(19) United States
(12) Patent Application Publication
(10) Pub. No.: US 2018/0332847 A1
(43) Pub. Date: Nov. 22, 2018

(54) ANTIMICROBIAL METAL CARBOXYLATE-BENZISOTHIAZOLINONE MIXTURES

(71) Applicant: Troy Corporation, Florham Park, NJ (US)

(72) Inventors: Kamlesh Gaglani, Belle Mead, NJ (US); Meihua Yang, Hillsborough, NJ (US)

(21) Appl. No.: 15/901,182

(22) Filed: Feb. 21, 2018

Related U.S. Application Data
(60) Provisional application No. 62/508,965, filed on May 19, 2017.

(51) Int. Cl. A01N 37/36; A01N 43/80; A01N 37/02; C09D 5/14; C09D 7/63; C09D 7/61

(52) U.S. Cl. CPC A01N 37/36; A01N 43/80; A01N 37/02; C08K 5/098; C09D 7/63; C09D 7/61; C09D 5/14

(57) ABSTRACT

Compositions of matter which include 1, 2-benzisothiazolin-3-one (also known as “BIT”) and a divalent metal carboxylate and exhibit desirable activity for inhibiting microbial growth are described. Methods for preserving an aqueous solution or dispersion from degradation by bacteria or fungus, and methods for preserving a dry film from degradation by bacteria or fungus, are also described.

The inventive mixtures provide greater antimicrobial protection per unit mass of metal carboxylate and BIT against certain microbes than is exhibited per unit mass by the metal carboxylate alone or by BIT alone.

Desirable antimicrobial activity has been observed with mixtures of the invention against Pseudomonas aeruginosa, Escherichia coli, Enterobacter aerogenes, and Alcaligenes faecalis, among others.

### BACKGROUND OF THE INVENTION

### Field of the Invention

The present invention relates to microbicidal compositions of matter and methods for inhibiting the growth of bacteria and other microbes.

### Description of Related Art

Exterior surfaces, interior surfaces and substrates of all types are prone to attack by bacterial microorganisms when exposed to moisture under mild conditions. Two or more types of microbes are frequently found in proximity with a particular surface or substrate, and the damage caused by various microbes acting simultaneously or in series can be especially significant. Consequently, broad spectrum microbicides that can protect against a range of microorganisms are of great commercial interest.

Benzisothiazolinone is a known preservative which has a bactericidal and a fungicidal mode of action. Benzisothiazolinone (also referred to as 1,2-benzisothiazol-3(2H)-one or “BIT”) is used, for example as a preservative in paints and cleaning products. BIT may be also be found in stains, car care products, textile solutions, metalworking fluids, oil recovery fluids, leather processing chemicals, pesticides, paper mill systems, and building products. In addition, BIT is commonly used in personal care products, such as sunscreens and liquid hand soaps.

While BIT is widely accepted as a reliable and cost-effective antimicrobial, it reportedly can cause irritation to the eyes, skin and lungs; and harm to aquatic life under certain conditions. Depending on the particular application, BIT may be monitored by the United States Food and Drug Administration or the United States Environmental Protection Agency. For these and other reasons, manufacturers and consumers alike would welcome alternative antimicrobials that are equally effective.

Divalent metal carboxylates, by themselves, have relatively low biocidal activity against most bacteria, fungi, and yeasts. Although some zinc carboxylates, such as zinc gluconate, are employed as preservatives in food and cosmetics, zinc gluconate is not regulated by the U.S. Environmental Protection Agency. The Select Committee on GRAS Substances of the U.S. Food and Drug Administration issued an SCOGS Opinion in 1978 which noted that certain gluconates, including zinc gluconates, are useful as nutritional supplements and found no evidence that demonstrated or reasonably suggested that zinc gluconate is a hazard to the public when used at then current levels. SCOGS Report No. 78, NTIS Accession No. PB288675(1978).

Calcium carboxylates also exhibit relatively low biocidal activity against most bacteria, fungi, and yeasts. Calcium gluconate, for example, is used as an inert ingredient in pesticide formulations applied to crops. It is generally recognized as safe by the USFDA for use as a direct food additive. It is used as a supplement to fortify beverages and foods lacking a sufficient amount of calcium.

Although, benzisothiazolinone and the above-described metal carboxylates have served well in many applications, the preservative industry would welcome an improved antimicrobial which is affordable and effective for protecting against a variety of microbes. Ideally, the improved antimicrobial will conserve resources and protect the environment by employing relatively small amounts of biologically active materials in an efficient manner.

### SUMMARY OF THE INVENTION

It has now been discovered that certain mixtures of divalent metal carboxylates and BIT exhibit unexpected levels of growth inhibition against a variety of bacteria, fungi and yeasts. The inventive mixtures can be used for preserving solutions, dispersions or dry film coatings from antimicrobial degradation.

In a preferred aspect, the invention is an antimicrobial composition of matter suitable for use as a preservative. The antimicrobial comprises a divalent metal carboxylate and BIT. The metal carboxylate is composed of divalent zinc or calcium cations and monovalent hydrocarbyl or hydroxycarbyl carboxylate anions. The hydrocarbyl or hydroxycarbyl group includes two to seven carbon atoms, while the carboxylate group includes another carbon atom. The mass ratio of metal carboxylate to BIT in the antimicrobial is in the range of about 1:1,000 to about 1,000:1.

In this aspect, the hydrocarbyl group may be ethylhexanoate, and the hydroxyhydrocarbyl group may be lactate, glycerate, gluconate, glycolate, levulinate or a mixture of thereof. The antimicrobial synergistically inhibits the growth of certain bacteria, fungi or yeasts.

In another aspect, the invention is a water-based paint that includes in the range of about 0.1 percent to about 10 percent of the antimicrobial composition described above or a dry film coating produced by drying this water-based paint of claim. The combination of BIT and metal carboxylates may be pre-blended for ease of incorporation in the paint as a single product rather than introducing two or more components individually.

In yet another aspect, the invention is a method for manufacturing a water-based, film-forming coating precursor that resists microbial degradation. In the method, a water-based, film-forming coating precursor is blended with the antimicrobial composition described above to produce an antimicrobial coating precursor that resists microbial degradation by inhibiting microbial growth of, for example, one or more of Alternaria alternata, Aureobasidium pullulans, Aspergillus niger, Trichoderma reesei, Penicillium species, Candida albicans, Saccharoamyces cervisiae, Pseudomonas aeruginosa, Acinetobacter calcoaciticus, Burkholderia cepacia, Enterobacter geroviae, Myroides odoratus, Proteus vulgaris, Serratia marcescens, Bacillus subtilis, Enterococcus faecilis, Escherichia coli, Klebsiella pneumoniae, Staphylococcus aureus, and Enterobacter aerogene.

In still another aspect, the invention provides a method for manufacturing a dry film coating which resists microbial degradation. The method is carried out as described above to produce an antimicrobial coating precursor that resists microbial degradation by inhibiting microbial growth. In addition, the antimicrobial coating precursor is exposed to an oxygen-containing gas to produce a dry film coating that resists microbial degradation.

In an additional aspect, the invention is an additive concentrate for use in water-based paint that comprises the antimicrobial composition described above.

### BRIEF DESCRIPTION OF THE DRAWINGS

FIG. 1 is a graph which depicts Minimum Inhibition Concentration (“MIC”) as a function of the mass ratio of calcium gluconate to BIT, for various microbes.

### DETAILED DESCRIPTION OF PREFERRED ASPECTS OF THE INVENTION

### Definitions

For the present purposes of the present invention:

a) “antimicrobial” means a material that is biologically active for inhibiting the growth of certain bacteria, fungi, or yeasts;

b) “antibacterial” means a material that is biologically active for inhibiting the growth of certain bacteria;

c) “antifungal” means a material that is biologically active for inhibiting the growth of certain fungi;

d) “yeast inhibitor” means a material that is biologically active for inhibiting the growth of certain yeasts;

e) “yeast” means unicellular organisms known as saccharomycetaceae which are capable of fermenting carbohydrates;

f) “Minimum Inhibitory Concentration” or “MIC” means the minimum concentration necessary to inhibit the growth of a microbe under standardized test conditions;

g) “Mass Frac_{X}” means the mass of X in a composition divided by the sum of the mass of X plus the mass of Y in the composition; where X is a metal carboxylate and Y is BIT to the extent that they are present;

h) “Mass FracY” means the mass of Y in a composition divided by the sum of the mass of X plus the mass of Y in the composition, where X is a metal carboxylate and Y is BIT to the extent that they are present.

The invention provides certain antimicrobial mixtures of divalent metal carboxylates and BIT which exhibit unexpected levels of growth inhibition against a variety of bacteria, fungi and yeasts; as well as methods for using the antimicrobials to preserve solutions, dispersions or dry film coatings from antimicrobial degradation.

In a preferred aspect, the invention is an antimicrobial composition of matter suitable for use as a preservative. The invention can be applied to produce a greater antimicrobial effect or, alternatively, a comparable antimicrobial effect with relatively less of the active materials.

Antimicrobial compositions are often called upon to protect against one or more unidentified microbes that are encountered in a particular application. To the extent that microbial growth as a whole is inhibited in the particular application, the antimicrobial composition is considered successful, The identity of the inhibited microbial may remain undetermined.

The antimicrobial composition of the present invention has been found synergistically effective against a number of precisely identified microbes in the laboratory. It is presumably also effective against as yet unidentified microbes which may proliferate indoors or outdoors. Without intending to limit the scope of the invention in any way, it is expected that the invention will inhibit the growth of many objectionable microbes that are capable of causing degradation to objects or harm to people or animals.

The antimicrobial of the present invention comprises a divalent metal carboxylate and BIT. The metal carboxylate of the invention is considered to be a biologically active ingredient for inhibiting growth of microbes, although the inhibitory activity of the metal carboxylate by itself may be relatively weak when compared to BIT or other traditional antimicrobials. It is contemplated that other biologically active ingredients, as well as adjuvants such as surfactants, pH buffering agent, c-solvents; divalent carboxylates can be successfully included in the inventive antimicrobial composition. Given the unpredictability of synergy between biologically active ingredients, each additional ingredient should be thoroughly investigated before use to determine whether the additional ingredient has affects the surprising antimicrobial activity of the present invention.

Illustrative examples of suitable metal carboxylates include calcium gluconate, calcium glycerate, calcium ethylhexanoate, calcium lactate, calcium glycolate, calcium levulinate, zinc gluconate, zinc glycerate, zinc ethylhexanoate, zinc lactate, zinc glycolate, levulinate, or a mixture thereof.

Metal carboxylates which include a total of three to eight carbon atoms are preferred. Metal carboxylates which include a univalent carboxyl radical and a hydrocarbyl or hydroxyhydrocarbyl group including two to seven carbon atoms are especially preferred. It is contemplated that other divalent carboxylates can be successfully utilized in the inventive antimicrobial composition. Most preferred are metal carboxylates in accordance with Formula I, as set forth below:

M⁺²[(R—COOH)⁻¹]₂ [FORMULA I]
where M⁺² is a metal cation, in which M is a metal in the +2 oxidation state and [(R—COOH)⁻¹] is a carboxylate anion having a net charge of −1; and where COOH is a carboxyl group and
R— is a hydrocarbyl group or a hydroxylhydrocarbyl group and includes two to seven carbon atoms.

The antimicrobial also comprises BIT. The mass ratio of metal carboxylate:BIT is preferably in the range of about 1:1000 to 1000:1, more preferably in the range of about 1:500 to 500:1; most preferably in the range of about 1:100 to 100:1; and ideally in the range of about 1:15 to about 15:1.

The surprising inhibitory of the inventive antimicrobial is a synergistic effect which can be determined experimentally and quantified in terms of its Synergy Index. Although the present invention is not limited to binary systems having exactly two biologically active materials, the definitions of “synergistic effect” and “Synergistic Index” proposed by F. C. Kull et al. for binary systems are hereby adopted for aspects of the present invention which are binary systems. These concepts have more recently been expanded to include tertiary systems and other multi-component systems, by methods which are known to practitioners in the field of antimicrobial biology.

For binary systems, “Synergistic effect” means the response of a mixture of two components which is greater than the sum of the response of the individual components. A mathematical approach for assessing synergy is reported by F. C. Kull, P. C. Elisman, H. D. Sylwestrowicz and P. K. Mayer, in Applied Microbiology, 9:538 (1961). For binary mixtures, the degree of synergistic effect for a range of proportions can be quantified in terms of its “Synergistic Index”, defined by the following equation.

Synergistic Index=Qₐ/Q_{A}+Q_{b}/Q_{B} [Equation No. 1]
where Qₐ=the quantity of component A used in a binary mixture that gives the desired effect
Q_{A}=the quantity of component A which when used alone gives the desired effect
Q_{b}=the quantity of component B used in a binary mixture that gives the desired effect
Q_{B}=the quantity of component B which when used alone gives the desired effect

In other preferred aspects, the invention is a water-based paint that includes about 0.1 to about 15 percent, more preferably 0.1 percent to about 10 percent, of the antimicrobial composition described above or a dry film coating produced by drying this water-based paint of claim.

In yet another preferred aspect, the invention is a method for manufacturing a water-based, film-forming coating precursor that resists microbial degradation. Under the appropriate conditions, the coating precursor undergoes a chemical reaction to become, for example a dry film paint coating, dry film plastic coating, or a dry-film friction control coating, or a dry fil adhesive coating.

In the method, a water-based, film-forming coating precursor is blended with the antimicrobial composition described above to produce an antimicrobial coating precursor that resists microbial degradation by inhibiting microbial growth of, for example, one or more of one or more of Alternaria alternata, Aureobasidium pullulans, Aspergillus niger, Trichoderma reesei, Penicillium species, Candida albicans, Saccharoamyces cervisiae, Pseudomonas aeruginosa, Acinetobacter calcoaciticus, Burkholderia cepacia, Enterobacter geroviae, Myroides odoratus, Proteus vulgaris, Serratia marcescens, Bacillus subtilis, Enterococcus faecilis, Escherichia coli, Klebsiella pneumoniae, Staphylococcus aureus, Enterobacter aerogene; preferably, one or more of Alternaria alternata, Candida albicans, Saccharoamyces cervisiae, Pseudomonas aeruginosa, Escherichia coli, Klebsiella pneumoniae, Staphylococcus aureus, Enterobacter aerogenes and Enterococcus faecalis. Most preferably, the antimicrobial coating precursor resists microbial degradation by inhibiting microbial one or more of Pseudomonas aeruginosa, Escherichia coli, Enterobacter aerogenes, and Enterococcus faecalis.

In still another preferred aspect, the invention provides a method for manufacturing a dry film coating which resists microbial degradation. The method is carried out as described above to produce an antimicrobial coating precursor that resists microbial degradation by inhibiting microbial growth. In addition, the antimicrobial coating precursor is exposed to an oxygen-containing gas to produce a dry film coating that resists microbial degradation. Preferably, the dry film coating resists microbial degradation by inhibiting microbial growth of, for example, one or more of Alternaria alternata, Candida albicans, Saccharoamyces cervisiae, Pseudomonas aeruginosa, Escherichia coli, Klebsiella pneumoniae, Staphylococcus aureus, Enterobacter aerogenes and Enterococcus faecalis. More preferably, the dry film coating resists microbial degradation by inhibiting microbial one or more of Pseudomonas aeruginosa, Escherichia coli, Enterobacter aerogenes, and Enterococcus faecalis.

In an additional preferred aspect, the invention is an additive concentrate for use in water-based paint that comprises the antimicrobial composition described above. For the present purposes, additive concentrate means a solution or dispersion which contains the antimicrobial composition of the invention in a concentration that is greater than that normally used to manufacture intermediate products or the final paint product. The additive concentrate treat is often cheaper to transport and easier to store than a similar solution or dispersion at the concentration utilized in the intermediate products or the final product. In some cases, the additive concentrate exhibits higher chemical stability, as compared to a similar or dispersion at the concentration in the intermediate product or the final product. For example, a solution or dispersion that is intended for use in water-based paint and has a concentration of the antimicrobial composition of the present invention which is greater than 15 percent would be considered to be an additive concentrate. The additive concentrate of the present invention is typically diluted after arrival at the point of use.

The following examples are presented to better communicate the invention, and are not intended to limit the invention in any way. Unless otherwise indicated, all references to parts, percentages, fractions, or proportions are based on mass.

### Example 1: Effectiveness of Aqueous Calcium Gluconate and BIT Compositions Against Alternaria alternata

Several antimicrobial compositions containing calcium gluconate, BIT, or both in water were investigated, as shown below in Table 1.

Minimum Inhibitory Concentration (“MIC”) for each of the antimicrobial compositions was determined against a test microbe, which in this case was a spore suspension of the fungus Alternaria alternata, with the aid of an Autoplate 4000 spiral plater that is commercially available from Spiral Biotech, Inc., Norwood, Mass., and its accompanying spiral gradient endpoint software (hereinafter referred to as “the SGE software”). The spiral plater automates the normal serial dilution method for determining MICs. Although the details of the SGE software are held confidentially by Spiral Biotech, Inc., they are believed to consistent with the principles set forth in “Measurement of MICs of antibacterial agents by spiral gradient endpoint compared with conventional dilution method” J. H. Paton, H. A. Holt, and M. J. Bywater—Int. J. Exp. Clin. Chemother, 1990.

Spore suspensions for the test microbe were prepared by growing Alternaria alternata on a Difco malt agar slant in an incubator for 1 week at 28° C. Spores were loosened by adding a small amount of buffer solution at pH 7.0 and scraping with a sterile nichrome wire loop. This process was repeated twice. The buffer solution included phosphate buffer and magnesium chloride, and was obtained commercially from Thomas Scientific Company, as Lot #023-0703.

Loosened spores were removed from the slant by aseptically pouring them into a sterile bottle containing 30 ml of the buffer solution and a volume of approximately 40 ml of 6 mm diameter borosilicate glass beads. The bead bottle was shaken to disperse the spores and adjusted to a final liquid volume of 50 ml. For use as a test inoculum, spore density was adjusted in distilled water blanks to that of a 0.5 McFarland nephelometer standard.

The spiral plater automatically applied 54.3 micro-liters of each antimicrobial composition of interest to the surface of 150 millimeter malt agar plates using an exponential application gradient. The concentration of the antimicrobial concentration was greatest near the center of the Petri plates and decreased toward the edges. Antimicrobial composition gradients were allowed to air dry at room temperature for 1 to 4 hours at 23° C. before inoculation with test microbe. Spiral gradient plates were inoculated by streaking with cotton swabs that had been soaked in test microbe spore suspension. Streaks were applied in a radial pattern, using a paper template generated by the SGE software to guide the application. Eight radii were inoculated per Petri plate. Each radius is considered as one replicated observation.

Inoculated spiral gradient plates were incubated for 48 hours in an incubator at 28° C. Visible growth of the test microbe developed along the radial streaks and ended where the concentration of the antimicrobial composition was sufficient to prevent growth. This growth endpoint value (expressed in mm as measured from center point of the Petri plate) was used to calculate MIC for the mixture, expressed as parts per million.

The maximum amount of calcium gluconate (without BIT) which the equipment at hand was capable of applying to the malt agar plates proved insufficient to prevent growth of Alternaria alternata. The maximum amount of calcium gluconate which the spiral plater actually applied corresponds to 768 ppm. Because some growth was observed for Alternaria alternata at 768 ppm of calcium gluconate (without BIT), the MIC for calcium gluconate is set forth below in Table 1 as “>768” ppm.

TABLE 1
Aqueous calcium gluconate-BIT compositions
and their observed MIC's for Alternaria alternata

| | | Mass | Mass | | MIC |
|---|---|---|---|---|---|
| | | Fraction_{CG} + | Fraction_{BIT} # | | (ppm) |
| | | (Mass_{CG}/ | Mass_{BIT}/ | Ratio | for |
| Trial | Invention or | Mass_{CG} + | Mass_{CG} + | (Mass_{CG}: | Alternaria |
| No. | Comparison | Mass_{BIT}) | Mass_{BIT}) | Mass_{BIT}) | alternata |
| 1 | Comparison | 0 | 1 | 0:1 | 13 |
| 2 = | Comparison | 0 | 1 | 0:1 | 13 |
| 3 | Invention | 0.25 | 0.75 | 1:3 | 11 |
| 4 | Invention | 0.5 | 0.5 | 1:1 | 8 |
| 5 | Invention | 0.5 | 0.5 | 1:1 | 12 |
| 6 | Invention | 0.75 | 0.25 | 3:1 | 14 |
| 7 | Comparison | 1 | 0 | 1:0 | >768 |
| 8 = | Comparison | 1 | 0 | 1:0 | >768 |

Legend: + Mass_{CG} means mass of calcium gluconate
# Mass_{BIT} means mass of BIT
= Trials 2 and 8 are retests at the same conditions as Trials 1 and 7, respectively

The data in Table 1 demonstrates that equivalent growth inhibition against Alternaria alternata can be achieved by certain calcium gluconate and BIT mixtures containing less BIT, as compared to growth inhibition by BIT alone. For example, when applied at 1:1 Mass Ratio of calcium gluconate to BIT, about 5 ppm of calcium gluconate and about 5 ppm of BIT provided the same antifungal inhibition as 13 ppm of BIT.

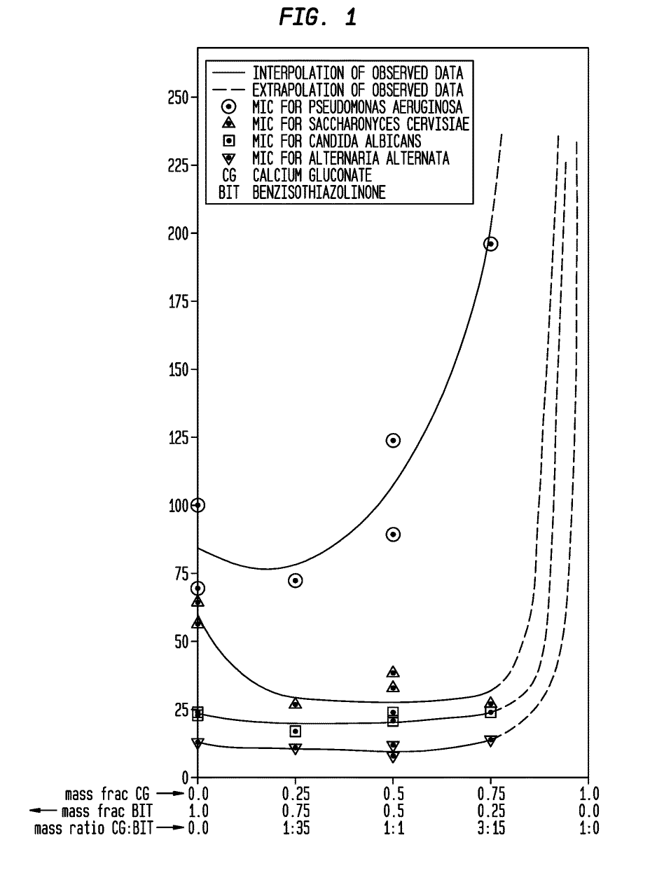

The data of Table 1 is presented graphically in FIG. 1. In addition to observed MIC's against Alternaria alternata, FIG. 1 depicts interpolations and extrapolations of the observed MIC values, which are indicated respectively by solid traces and dashed traces. The extrapolations for Alternaria alternata are based on the observed MIC values and the observation that the MIC of calcium gluconate alone against Alternaria alternate is greater than 768 ppm.

The MIC data of Table 1 and Equation 1 above are used to calculate Synergy Indices shown in Table 2. These Synergy Indices indicate that the inventive mixtures of calcium gluconate and BIT exhibit synergy for inhibiting Alternaria alternata.

TABLE 2
Calculated Synergy Indices of calcium gluconate-BIT compositions
Based on their observed MIC's for Alternaria alternata

| | | | MIC | | | | | |
|---|---|---|---|---|---|---|---|---|
| | Invention | Mass | (ppm) for | | | | | |
| Trial | or | Ratio | Alternaria | | | | | |
| No. | Comparison | (Mass_{CG}:Mass_{BIT}) | alternata | Qa | QA | Qb | QB | SI |
| 1 | Comparison | 0:1 | 13 | 0 | >768 | 13 | 13 | Not |
| | | | | | | | | Applicable |
| 2 | Comparison | 0:1 | 13 | 0 | >768 | 13 | 13 | Not |
| | | | | | | | | Applicable |
| 3 | Invention | 1:3 | 11 | 2.75 | >768 | 8.25 | 13 | <0.638 |
| 4 | Invention | 1:1 | 8 | 4 | >768 | 4 | 13 | <0.313 |
| 5 | Invention | 1:1 | 12 | 6 | >768 | 6 | 13 | <0.469 |
| 6 | Invention | 3:1 | 14 | 10.5 | >768 | 3.5 | 13 | <0.245 |
| 7 | Comparison | 1:0 | >768 | 768 | >768 | 0 | 13 | Not |
| | | | | | | | | Applicable |
| 8 | Comparison | 1:0 | >768 | 768 | >768 | 0 | 13 | Not |
| | | | | | | | | Applicable |

Legend:
+ Mass_{CG} means mass of calcium gluconate
# Mass_{BIT} means mass of BIT
= Trials 2 and 8 are retests at the same conditions as Trials 1 and 7, respectively

Inspection of FIG. 1 indicates that certain calcium gluconate-BIT-water mixtures that contain lesser amounts of BIT, as compared to BIT-water mixtures of corresponding total mass, exhibit comparable inhibitory activity against Alternaria alternata. This result is especially surprising considering that calcium gluconate alone in water failed to produce growth inhibition against Alternaria alternata when applied at 768 ppm.

The MIC data of Table 1 and Table 2 are presented graphically in FIG. 1. FIG. 1 also depicts interpolations and extrapolations of the observed MIC values, which are indicated respectively by solid traces and dashed traces. The extrapolations for Alternaria alternata are based on the observed MIC values and the observation that 768 ppm calcium gluconate alone failed to inhibit the growth of Alternaria alternate. It can be seen that mixtures of calcium gluconate and BIT can be used to replace BIT as an antifungal for inhibiting the growth of Alternaria alternata.

### Example 2: Effectiveness of Aqueous Calcium Gluconate and BIT Compositions Against Candida albicans

Utilizing the procedure described above in Example, Minimum Inhibitory Concentration (“MIC”) for each of the antimicrobial compositions was determined against a test microbe, which in this case was a spore suspension of the yeast Candida albicans., as described above in Example 1. Several antimicrobial compositions containing calcium gluconate, BIT, or both in water were investigated, as shown below in Table 3

The maximum amount of calcium gluconate (without BIT) which the equipment at hand was capable of applying to the malt agar plates proved insufficient to prevent growth of Candida albicans. The maximum amount of calcium gluconate which the spiral plater actually applied corresponds to 768 ppm. Because some growth was observed for Candida albicans at 768 ppm of calcium gluconate (without BIT), the MIC for calcium gluconate is set forth below in Table 3 as “>768”.

TABLE 3
Aqueous calcium gluconate-BIT compositions and their observed
MIC's for Candida albicans

| | | Mass | Mass | | MIC |
|---|---|---|---|---|---|
| | | Fraction_{CG} + | Fraction_{BIT} # | | (ppm) |
| | | (Mass_{CG}/ | Mass_{BIT}/ | Ratio | for |
| Trial | Invention or | Mass_{CG} + | Mass_{CG} + | (Mass_{CG}: | Candida |
| No. | Comparison | Mass_{BIT}) | Mass_{BIT}) | Mass_{BIT}) | albicans |
| 1 | Comparison | 0 | 1 | 0:1 | 23 |
| 2 = | Comparison | 0 | 1 | 0:1 | 24 |
| 3 | Invention | 0.25 | 0.75 | 1:3 | 17 |
| 4 | Invention | 0.5 | 0.5 | 1:1 | 21 |
| 5 | Invention | 0.5 | 0.5 | 1:1 | 24 |
| 6 | Invention | 0.75 | 0.25 | 3:1 | 24 |
| 7 | Comparison | 1 | 0 | 1:0 | >768 |
| 8 = | Comparison | 1 | 0 | 1:0 | >768 |

Legend: + Mass_{CG} means mass of calcium gluconate
# Mass_{BIT} means mass of BIT
= Trials 2 and 8 are retests at the same conditions as Trials 1 and 7, respectively

The MIC data in Table 3 and Equation 1 above were used to calculate the Synergy Index (“SI”) for each of the inventive compositions presented in Table 3. The calculated Synergy Indices are tabulated below in Table 4.

TABLE 4
Calculated Synergy Indices of calcium gluconate-BIT compositions
Based on their observed MIC's for Candida albicans

| | | | MIC | | | | | |
|---|---|---|---|---|---|---|---|---|
| | Invention | Mass | (ppm) for | | | | | |
| Trial | or | Ratio | Candida | | | | | |
| No. | Comparison | (Mass_{CG}:Mass_{BIT}) | albicans | Qa | QA | Qb | QB | SI |
| 1 | Comparison | 0:1 | 23 | 0 | >768 | 23 | 23.5 | Not |
| | | | | | | | | Applicable |
| 2 | Comparison | 0:1 | 24 | 0 | >768 | 24 | 23.5 | Not |
| | | | | | | | | Applicable |
| 3 | Invention | 1:3 | 17 | 4.25 | >768 | 12.75 | 23.5 | <0.548 |
| 4 | Invention | 1:1 | 21 | 10.5 | >768 | 10.5 | 23.5 | <0.460 |
| 5 | Invention | 1:1 | 24 | 12 | >768 | 12 | 23.5 | <0.526 |
| 6 | Invention | 3:1 | 24 | 18 | >768 | 6 | 23.5 | <0.279 |
| 7 | Comparison | 1:0 | >768 | 768 | >768 | 0 | 23.5 | Not |
| | | | | | | | | Applicable |
| 8 | Comparison | 1:0 | >768 | 768 | >768 | 0 | 23.5 | Not |
| | | | | | | | | Applicable |

Legend:
+ Mass_{CG} means mass of calcium gluconate
# Mass_{BIT} means mass of BIT
= Trials 2 and 8 are retests at the same conditions as Trials 1 and 7, respectively

The data in Table 4 demonstrates that equivalent growth inhibition against Candida albicans can be achieved by certain calcium gluconate and BIT mixtures containing less BIT, as compared to growth inhibition by BIT alone. For example, when applied at 1:1 Mass Ratio of calcium gluconate to BIT, about 11 ppm of calcium gluconate and about 11 ppm of BIT provided the same antifungal inhibition as 23 ppm of BIT.

The data of Table 3 and Table 4 are presented graphically in FIG. 1. In addition to observed MIC's against Candida albicans, FIG. 1 depicts interpolations and extrapolations of the observed MIC values, which are indicated respectively by solid traces and dashed traces. The extrapolations for Candida albicans are based on the observed MIC values and the observation that 768 ppm of calcium gluconate alone failed to inhibit the growth of Candida albicans. It can be seen from FIG. 1 that mixtures of calcium gluconate and BIT can be used to replace BIT as an antifungal for inhibiting the growth of the yeast Candida albicans.

### Example 3: Effectiveness of Aqueous Calcium Gluconate and BIT Compositions Against Saccharomyces cervisiae

Utilizing the procedure described above in Example 1, Minimum Inhibitory Concentration (“MIC”) for each of the antimicrobial compositions was determined against a test microbe, which in this case was a spore suspension of the yeast Saccharomyces cervisiae. Several antimicrobial compositions containing calcium gluconate, BIT, or both in water were investigated, as shown below in Table 5.

The maximum amount of calcium gluconate (without BIT) which the equipment at hand was capable of applying to the malt agar plates proved insufficient to prevent growth of Saccharomyces cervisiae. The maximum amount of calcium gluconate which the spiral plater actually applied corresponds to 768 ppm. Because some growth was observed for Saccharomyces cervisiae at 768 ppm of calcium gluconate (without BIT), the MIC for calcium gluconate is set forth below in Table 5 as “>768”.

TABLE 5
Aqueous calcium gluconate-BIT compositions and their observed
MIC's for Saccharomyces cervisiae

| | | Mass | Mass | | MIC |
|---|---|---|---|---|---|
| | Invention | Fraction_{CG} + | Fraction_{BIT} # | | (ppm) for |
| | or | (Mass_{CG}/ | Mass_{BIT}/ | Ratio | Saccharo- |
| Trial | Compar- | Mass_{CG} + | Mass_{CG} + | (Mass_{CG}: | myces |
| No. | ison | Mass_{BIT}) | Mass_{BIT}) | Mass_{BIT}) | cervisiae |
| 1 | Compar- | 0 | 1 | 0:1 | 57 |
| | ison | | | | |
| 2 = | Compar- | 0 | 1 | 0:1 | 65 |
| | ison | | | | |
| 3 | Invention | 0.25 | 0.75 | 1:3 | 27 |
| 4 | Invention | 0.5 | 0.5 | 1:1 | 33 |
| 5 | Invention | 0.5 | 0.5 | 1:1 | 39 |
| 6 | Invention | 0.75 | 0.25 | 3:1 | 27 |
| 7 | Compar- | 1 | 0 | 1:0 | >768 |
| | ison | | | | |
| 8 = | Compar- | 1 | 0 | 1:0 | >768 |
| | ison | | | | |

Legend: + Mass_{CG} means mass of calcium gluconate
# Mass_{BIT} means mass of BIT
= Trials 2 and 8 are retests at the same conditions as Trials 1 and 7, respectively

The MIC data in Table 5 and Equation 1 above were used to calculate the Synergy Index (“SI”) for each of the inventive compositions presented in Table 5. The calculated Synergy Indices are tabulated below in Table 6.

TABLE 6
Calculated Synergy Indices of calcium gluconate-BIT compositions
Based on their observed MIC's for Saccharomyces cervisiae

| | Invention | Mass | MIC (ppm) for | | | | | |
|---|---|---|---|---|---|---|---|---|
| Trial | or | Ratio | Saccharomyces | | | | | |
| No. | Comparison | (Mass_{CG}:Mass_{BIT}) | cervisiae | Qa | QA | Qb | QB | SI |
| 1 | Comparison | 0:1 | 57 | 0 | >768 | 23 | 61 | Not |
| | | | | | | | | Applicable |
| 2 | Comparison | 0:1 | 65 | 0 | >768 | 24 | 61 | Not |
| | | | | | | | | Applicable |
| 3 | Invention | 1:3 | 27 | 6.75 | >768 | 20.25 | 61 | <0.341 |
| 4 | Invention | 1:1 | 33 | 16.5 | >768 | 16.5 | 61 | <0.267 |
| 5 | Invention | 1:1 | 39 | 19.5 | >768 | 19.5 | 61 | <0.345 |
| 6 | Invention | 3:1 | 27 | 20.25 | >768 | 6.75 | 61 | <0.137 |
| 7 | Comparison | 1:0 | >768 | 768 | >768 | 0 | 61 | Not |
| | | | | | | | | Applicable |
| 8 | Comparison | 1:0 | >768 | 768 | >768 | 0 | 61 | Not |
| | | | | | | | | Applicable |

Legend:
+ Mass_{CG} means mass of calcium gluconate
# Mass_{BIT} means mass of BIT
= Trials 2 and 8 are retests at the same conditions as Trials 1 and 7, respectively

The data in Table 6 demonstrates that equivalent growth inhibition against Saccharomyces cervisiae can be achieved by certain calcium gluconate and BIT mixtures containing less BIT, as compared to growth inhibition by BIT alone. For example, when applied at 1:1 Mass Ratio of calcium gluconate to BIT, about 18 ppm of calcium gluconate and about 18 ppm of BIT provided the same antifungal inhibition as 61 ppm of BIT.

The data of Table 5 and Table 6 are presented graphically in FIG. 1. In addition to observed MIC's against Saccharomyces cervisiae, FIG. 1 depicts interpolations and extrapolations of the observed MIC values, which are indicated respectively by solid traces and dashed traces. The extrapolations for Saccharomyces cervisiae are based on the observed MIC values and the observation that 768 ppm of calcium gluconate alone failed to inhibit the growth of Saccharomyces cervisiae. It can be seen from FIG. 1 that mixtures of calcium gluconate and BIT can be used to replace BIT as an antifungal for inhibiting the growth of the yeast Saccharomyces cervisiae.

### Example 4: Effectiveness of Aqueous Calcium Gluconate and BIT Compositions Against Pseudomonas aeruginosa

Utilizing the procedure described above in Example 1, Minimum Inhibitory Concentration (“MIC”) for each of the antimicrobial compositions was determined against a test microbe, which in this case was a spore suspension of the bacterium Pseudomonas aeruginosa. Several antimicrobial compositions containing calcium gluconate, BIT, or both in water were investigated, as shown below in Table 7.

The maximum amount of calcium gluconate (without BIT) which the equipment at hand was capable of applying to the malt agar plates proved insufficient to prevent growth of Pseudomonas aeruginosa. The maximum amount of calcium gluconate which the spiral plater actually applied corresponds to >1127 ppm. Because some growth was observed for Pseudomonas aeruginosa at ppm of calcium gluconate (without BIT), the MIC for calcium gluconate is set forth below in Table 7 as “>1127”.

TABLE 7
Aqueous calcium gluconate-BIT compositions and their
observed MIC's for Pseudomonas aeruginosa

| | | Mass | Mass | | MIC |
|---|---|---|---|---|---|
| | Invention | Fraction_{CG} + | Fraction_{BIT} # | | (ppm) for |
| | or | (Mass_{CG}/ | Mass_{BIT}/ | Ratio | Pseudo- |
| Trial | Compar- | Mass_{CG} + | Mass_{CG} + | (Mass_{CGLY}: | monas |
| No. | ison | Mass_{BIT}) | Mass_{BIT}) | Mass_{BIT}) | aeruginosa |
| 1 | Compar- | 0 | 1 | 0:1 | 70 |
| | ison | | | | |
| 2 = | Compar- | 0 | 1 | 0:1 | 101 |
| | ison | | | | |
| 3 | Invention | 0.25 | 0.75 | 1:3 | 73 |
| 4 | Invention | 0.5 | 0.5 | 1:1 | 90 |
| 5 | Invention | 0.5 | 0.5 | 1:1 | 125 |
| 6 | Invention | 0.75 | 0.25 | 3:1 | 198 |
| 7 | Compar- | 1 | 0 | 1:0 | >1127 |
| | ison | | | | |
| 8 = | Compar- | 1 | 0 | 1:0 | >1127 |
| | ison | | | | |

Legend: + Mass_{CG} means mass of calcium gluconate
# Mass_{BIT} means mass of BIT
= Trials 2 and 8 are retests at the same conditions as Trials 1 and 7, respectively

The MIC data in Table 7 and Equation 1 above were used to calculate the Synergy Index (“SI”) for each of the inventive compositions presented in Table 7. The calculated Synergy Indices are tabulated below in Table 8.

TABLE 8
Calculated Synergy Indices of calcium gluconate-BIT compositions
Based on their observed MIC's for Pseudomonas aeruginosa

| | Invention | Mass | MIC (ppm) for | | | | | |
|---|---|---|---|---|---|---|---|---|
| Trial | or | Ratio | Pseudomonas | | | | | |
| No. | Comparison | (Mass_{CG}:Mass_{BIT}) | aeruginosa | Qa | QA | Qb | QB | SI |
| 1 | Comparison | 0:1 | 70 | 0 | >1127 | 70 | 85 | Not |
| | | | | | | | | Applicable |
| 2 | Comparison | 0:1 | 101 | 0 | >1127 | 101 | 85 | Not |
| | | | | | | | | Applicable |
| 3 | Invention | 1:3 | 73 | 18.25 | >1127 | 54.75 | 85 | <0.660 |
| 4 | Invention | 1:1 | 90 | 45 | >1127 | 45 | 85 | <0.569 |
| 5 | Invention | 1:1 | 125 | 62.5 | >1127 | 62.5 | 85 | <0.791 |
| 6 | Invention | 3:1 | 198 | 148.5 | >1127 | 49.5 | 85 | <0.714 |
| 7 | Comparison | 1:0 | >1127 | 1127 | >1127 | 0 | 85 | Not |
| | | | | | | | | Applicable |
| 8 | Comparison | 1:0 | >1127 | 1127 | >1127 | 0 | 85 | Not |
| | | | | | | | | Applicable |

Legend:
+ Mass_{CG} means mass of calcium gluconate
# Mass_{BIT} means mass of BIT
= Trials 2 and 8 are retests at the same conditions as Trials 1 and 7, respectively

The data in Table 8 demonstrate that equivalent growth inhibition against Pseudomonas aeruginosa can be achieved by certain calcium gluconate and BIT mixtures containing less BIT, as compared to growth inhibition by BIT alone. For example, when applied at 1:1 Mass Ratio of calcium gluconate to BIT, about 54 ppm of calcium gluconate and about 54 ppm of BIT provided the same antifungal inhibition as 85 ppm of BIT.

The data of Table 7 and Table 8 are presented graphically in FIG. 1. In addition to observed MIC's against Pseudomonas aeruginosa, FIG. 1 depicts interpolations and extrapolations of the observed MIC values, which are indicated respectively by solid traces and dashed traces. The extrapolations for Pseudomonas aeruginosa are based on the observed MIC values and the observation that 1127 ppm of calcium gluconate alone failed to inhibit the growth of Pseudomonas aeruginosa. It can be seen from FIG. 1 that mixtures of calcium gluconate and BIT can be used to replace BIT as an antifungal for inhibiting the growth of Pseudomonas aeruginosa.

### Example 5: Effectiveness of Aqueous Calcium Glycerate and BIT Compositions Against Alternaria alternata

Utilizing the procedure described above in Example 1, Minimum Inhibitory Concentration (“MIC”) for each of the antimicrobial compositions was determined against a test microbe, which in this case was a spore suspension of the bacterium Alternaria alternata. Several antimicrobial compositions containing calcium glycerate, BIT, or both in water were investigated, as shown below in Table 9.

The maximum amount of calcium glycerate (without BIT) which the equipment at hand was capable of applying to the malt agar plates proved insufficient to prevent growth of Alternaria alternata. The maximum amount of calcium glycerate which the spiral plater actually applied corresponds to >788 ppm. Because some growth was observed for Alternaria alternata at ppm of calcium glycerate (without BIT), the MIC for calcium glycerate is set forth below in Table 9 as “>788”.

TABLE 9
Aqueous calcium glycerate-BIT compositions and their
observed MIC's for Alternaria alternata

| | | Mass | Mass | | |
|---|---|---|---|---|---|
| | | Fraction_{CGLY}+ | Fraction_{BIT}# | Mass | MIC |
| | Invention | (Mass_{CG}/ | (Mass_{BIT}/ | Ratio | (ppm) for |
| Trial | or | Mass_{CGLY} + | Mass_{CGLY} + | (Mass_{CGLY}: | Alternaria |
| No. | Comparison | Mass_{BIT}) | Mass_{BIT}) | Mass_{BIT}) | alternata |
| 1 | Comparison | 0 | 1 | 0:1 | 8 |
| 2 = | Comparison | 0 | 1 | 0:1 | 8 |
| 3 | Invention | 0.25 | 0.75 | 1:3 | 7 |
| 4 | Invention | 0.5 | 0.5 | 1:1 | 6 |
| 5 | Invention | 0.5 | 0.5 | 1:1 | 6 |
| 6 | Invention | 0.75 | 0.25 | 3:1 | 19 |
| 7 | Comparison | 1 | 0 | 1:0 | >788 |
| 8 = | Comparison | 1 | 0 | 1:0 | >788 |

Legend: +Mass_{CGLY} means mass of calcium glycerate
#Mass_{BIT} means mass of BIT
= Trials 2 and 8 are retests at the same conditions as Trials 1 and 7, respectively

The MIC data in Table 9 and Equation 1 above were used to calculate the Synergy Index (“SI”) for each of the inventive compositions presented in Table. The calculated Synergy Indices are tabulated below in Table 10.

TABLE 10
Calculated Synergy Indices of calcium glycerate-BIT compositions
Based on their observed MIC's for Alternaria alternata

| | | | MIC (ppm) | | | | | |
|---|---|---|---|---|---|---|---|---|
| | Invention | Mass | for | | | | | |
| Trial | or | Ratio | Alternaria | | | | | |
| No. | Comparison | (Mass_{CGLY}:Mass_{BIT}) | alternata | Qa | QA | Qb | QB | SI |
| 1 | Comparison | 0:1 | 8 | 0 | >1127 | 70 | 85 | Not |
| | | | | | | | | Applicable |
| 2 | Comparison | 0:1 | 8 | 0 | >1127 | 101 | 85 | Not |
| | | | | | | | | Applicable |
| 3 | Invention | 1:3 | 7 | 18.25 | >1127 | 54.75 | 85 | <0.660 |
| 4 | Invention | 1:1 | 6 | 45 | >1127 | 45 | 85 | <0.569 |
| 5 | Invention | 1:1 | 6 | 62.5 | >1127 | 62.5 | 85 | <0.791 |
| 6 | Invention | 3:1 | 19 | 148.5 | >1127 | 49.5 | 85 | <0.714 |
| 7 | Comparison | 1:0 | >788 | 1127 | >1127 | 0 | 85 | Not |
| | | | | | | | | Applicable |
| 8 | Comparison | 1:0 | >788 | 1127 | >1127 | 0 | 85 | Not |
| | | | | | | | | Applicable |

Legend:
+ Mass_{CGLY} means mass of calcium glycerate
# Mass_{BIT} means mass of BIT
= Trials 2 and 8 are retests at the same conditions as Trials 1 and 7, respectively

The data in Table 10 demonstrates that equivalent growth inhibition against Alternaria alternata can be achieved by certain calcium glycerate and BIT mixtures containing less BIT, as compared to growth inhibition by BIT alone. For example, when applied at 1:1 Mass Ratio of calcium glycerate to BIT, about 54 ppm of calcium glycerate and about 54 ppm of BIT provided the same antifungal inhibition as 85 ppm of BIT.

### Example 6: Effectiveness of Aqueous Calcium Glycerate and BIT Compositions Against Candida albicans

Utilizing the procedure described above in Example 1, Minimum Inhibitory Concentration (“MIC”) for each of the antimicrobial compositions was determined against a test microbe, which in this case was a spore suspension of the yeast Candida albicans. Several antimicrobial compositions containing calcium glycerate, BIT, or both in water were investigated, as shown below in Table 11.

The maximum amount of calcium glycerate (without BIT) which the equipment at hand was capable of applying to the malt agar plates proved insufficient to prevent growth of Candida albicans. The maximum amount of calcium glycerate which the spiral plater actually applied corresponds to >768 ppm. Because some growth was observed for Candida albicans at 768 ppm of calcium glycerate (without BIT), the MIC for calcium glycerate is set forth below in Table 11 as “>768”.

TABLE 11
Aqueous calcium glycerate-BIT compositions and their
observed MIC's for Candida albicans

| | | Mass | Mass | | |
|---|---|---|---|---|---|
| | | Fraction_{CGLY}+ | Fraction_{BIT}# | Mass | MIC |
| | Invention | (Mass_{CGLY}/ | (Mass_{BIT}/ | Ratio | (ppm) for |
| Trial | or | Mass_{CGLY} + | Mass_{CGLY} + | (Mass_{CGLY}: | Candida |
| No. | Comparison | Mass_{BIT}) | Mass_{BIT}) | Mass_{BIT}) | albicans |
| 1 | Comparison | 0 | 1 | 0:1 | 12 |
| 2 = | Comparison | 0 | 1 | 0:1 | 20 |
| 3 | Invention | 0.25 | 0.75 | 1:3 | 13 |
| 4 | Invention | 0.5 | 0.5 | 1:1 | 11 |
| 5 | Invention | 0.5 | 0.5 | 1:1 | 16 |
| 6 | Invention | 0.75 | 0.25 | 3:1 | 27 |
| 7 | Comparison | 1 | 0 | 1:0 | >788 |
| 8 = | Comparison | 1 | 0 | 1:0 | >788 |

Legend: +Mass_{CGLY} means mass of calcium glycerate
#Mass_{BIT} means mass of BIT
= Trials 2 and 8 are retests at the same conditions as Trials 1 and 7, respectively

The MIC data in Table 11 and Equation 1 above were used to calculate the Synergy Index (“SI”) for each of the inventive compositions presented in Table. The calculated Synergy Indices are tabulated below in Table 12.

TABLE 12
Calculated Synergy Indices of calcium glycerate-BIT compositions
Based on their observed MIC's for Candida albicans

| | | | MIC (ppm) | | | | | |
|---|---|---|---|---|---|---|---|---|
| | Invention | | for | | | | | |
| Trial | or | Mass Ratio | Candida | | | | | |
| No. | Comparison | (Mass_{CGLY}:Mass_{BIT}) | albicans | Qa | QA | Qb | QB | SI |
| 1 | Comparison | 0:1 | 12 | 0 | >768 | 12 | 16 | Not |
| | | | | | | | | Applicable |
| 2 | Comparison | 0:1 | 20 | 0 | >768 | 20 | 16 | Not |
| | | | | | | | | Applicable |
| 3 | Invention | 1:3 | 13 | 3.25 | >768 | 9.75 | 16 | <0.613 |
| 4 | Invention | 1:1 | 11 | 5.5 | >768 | 5.5 | 16 | <0.351 |
| 5 | Invention | 1:1 | 16 | 8 | >768 | 8 | 16 | <0.510 |
| 6 | Invention | 3:1 | 27 | 20.25 | >768 | 6.75 | 16 | <0.448 |
| 7 | Comparison | 1:0 | >768 | 768 | >768 | 0 | 16 | Not |
| | | | | | | | | Applicable |
| 8 | Comparison | 1:0 | >768 | 768 | >768 | 0 | 16 | Not |
| | | | | | | | | Applicable |

Legend:
+ Mass_{CGLY} means mass of calcium glycerate
# Mass_{BIT} means mass of BIT
= Trials 2 and 8 are retests at the same conditions as Trials 1 and 7, respectively

The data in Table 12 demonstrates that equivalent growth inhibition against Candida albicans can be achieved by certain calcium glycerate and BIT mixtures containing less BIT, as compared to growth inhibition by BIT alone. For example, when applied at 1:1 Mass Ratio of calcium glycerate to BIT, about 7 ppm of calcium glycerate and about 7 ppm of BIT provided the same inhibition as 85 ppm of BIT against Candida albicans.

### Example 7: Effectiveness of Aqueous Calcium Glycerate and BIT Compositions Against Pseudomonas aeruginosa

Utilizing the procedure described above in Example 1, Minimum Inhibitory Concentration (“MIC”) for each of the antimicrobial compositions was determined against a test microbe, which in this case was a spore suspension of the yeast Pseudomonas aeruginosa. Several antimicrobial compositions containing calcium glycerate, BIT, or both in water were investigated, as shown below in Table 13.

The maximum amount of calcium glycerate (without BIT) which the equipment at hand was capable of applying to the malt agar plates proved insufficient to prevent growth of Pseudomonas aeruginosa. The maximum amount of calcium glycerate which the spiral plater actually applied corresponds to >1230 ppm. Because some growth was observed for Pseudomonas aeruginosa at 1230 ppm of calcium glycerate (without BIT), the MIC for calcium glycerate is set forth below in Table 13 as “>1230”.

TABLE 13
Aqueous calcium glycerate-BIT compositions and their
observed MIC's for Pseudomonas aeruginosa

| | | Mass | Mass | | |
|---|---|---|---|---|---|
| | Invention | Fraction_{CGLY}+ | Fraction_{BIT}# | Mass | MIC |
| | or | (Mass_{CGLY}/ | (Mass_{BIT}/ | Ratio | (ppm) for |
| Trial | Compar- | Mass_{CGLY} + | Mass_{CGLY} + | (Mass_{CGLY}: | Pseudomonas |
| No. | ison | Mass_{BIT}) | Mass_{BIT}) | Mass_{BIT}) | aeruginosa |
| 1 | Compar- | 0 | 1 | 0:1 | 23 |
| | ison | | | | |
| 2 = | Compar- | 0 | 1 | 0:1 | 32 |
| | ison | | | | |
| 3 | Invention | 0.25 | 0.75 | 1:3 | 24 |
| 4 | Invention | 0.5 | 0.5 | 1:1 | 17 |
| 5 | Invention | 0.5 | 0.5 | 1:1 | 19 |
| 6 | Invention | 0.75 | 0.25 | 3:1 | 34 |
| 7 | Compar- | 1 | 0 | 1:0 | >1230 |
| | ison | | | | |
| 8 = | Compar- | 1 | 0 | 1:0 | >1230 |
| | ison | | | | |

Legend: +Mass_{CGLY} means mass of calcium glycerate
#Mass_{BIT} means mass of BIT
= Trials 2 and 8 are retests at the same conditions as Trials 1 and 7, respectively

The MIC data in Table 13 and Equation 1 above were used to calculate the Synergy Index (“SI”) for each of the inventive compositions presented in Table 13. The calculated Synergy Indices are tabulated below in Table 14.

TABLE 14
Calculated Synergy Indices of calcium glycerate-BIT compositions
Based on their observed MIC's for Pseudomonas aeruginosa

| | | | MIC (ppm) | | | | | |
|---|---|---|---|---|---|---|---|---|
| | Invention | | for | | | | | |
| Trial | or | Mass Ratio | Pseudomonas | | | | | |
| No. | Comparison | (Mass_{CGLY}:Mass_{BIT}) | aeruginosa | Qa | QA | Qb | QB | SI |
| 1 | Comparison | 0:1 | 23 | 0 | >1230 | 23 | 27.5 | Not |
| | | | | | | | | Applicable |
| 2 | Comparison | 0:1 | 32 | 0 | >1230 | 32 | 27.5 | Not |
| | | | | | | | | Applicable |
| 3 | Invention | 1:3 | 24 | 6 | >1230 | 18 | 27.5 | <0.659 |
| 4 | Invention | 1:1 | 17 | 8.5 | >1230 | 8.5 | 27.5 | <0.316 |
| 5 | Invention | 1:1 | 19 | 9.5 | >1230 | 9.5 | 27.5 | <0.353 |
| 6 | Invention | 3:1 | 34 | 25.5 | >1230 | 8.5 | 27.5 | <0.319 |
| 7 | Comparison | 1:0 | >1230 | 1230 | >1230 | 0 | 27.5 | Not |
| | | | | | | | | Applicable |
| 8 | Comparison | 1:0 | >1230 | 1230 | >1230 | 0 | 27.5 | Not |
| | | | | | | | | Applicable |

Legend:
+ Mass_{CGLY} means mass of calcium glycerate
# Mass_{BIT} means mass of BIT
= Trials 2 and 8 are retests at the same conditions as Trials 1 and 7, respectively

The data in Table 14 demonstrates that equivalent growth inhibition against Pseudomonas aeruginosa can be achieved by certain calcium glycerate and BIT mixtures containing less BIT, as compared to growth inhibition by BIT alone. For example, when applied at 1:1 Mass Ratio of calcium glycerate to BIT, about 9 ppm of calcium glycerate and about 9 ppm of BIT provided the same inhibition as 27.5 ppm of BIT against Pseudomonas aeruginosa.

### Example 8: Effectiveness of Aqueous Calcium Ethylhexanoate and BIT Compositions Against Alternaria alternata

Utilizing the procedure described above in Example 1, Minimum Inhibitory Concentration (“MIC”) for each of the antimicrobial compositions was determined against a test microbe, which in this case was a spore suspension of the fungus Alternaria alternata. Several antimicrobial compositions containing calcium ethylhexanoate, BIT, or both in water were investigated, as shown below in Table 15.

As an average of two trials, the amount of calcium ethylhexanoate (without BIT) required to prevent growth of Alternaria alternata was 7.5 ppm. All observed values for MIC are presented below in Table 15.

TABLE 15
Aqueous calcium ethylhexanoate-BIT compositions and their
observed MIC's for Alternaria alternate

| | | Mass | Mass | | |
|---|---|---|---|---|---|
| | | Fraction_{CEHA}+ | Fraction_{BIT}# | Mass | MIC |
| | Invention | (Mass_{CEHA}/ | (Mass_{BIT}/ | Ratio | (ppm) for |
| Trial | or | Mass_{CEHA} + | Mass_{CEHA} + | (Mass_{CEHA}: | Alternaria |
| No. | Comparison | Mass_{BIT}) | Mass_{BIT}) | Mass_{BIT}) | alternate |
| 1 | Comparison | 0 | 1 | 0:1 | 13 |
| 2 = | Comparison | 0 | 1 | 0:1 | 13 |
| 3 | Invention | 0.25 | 0.75 | 1:3 | 10 |
| 4 | Invention | 0.5 | 0.5 | 1:1 | 8 |
| 5 | Invention | 0.5 | 0.5 | 1:1 | 8 |
| 6 | Invention | 0.75 | 0.25 | 3:1 | 7 |
| 7 | Comparison | 1 | 0 | 1:0 | 8 |
| 8 = | Comparison | 1 | 0 | 1:0 | 7 |

Legend: +Mass_{CEHA} means mass of calcium ethylhexanoate
#Mass_{BIT} means mass of BIT
= Trials 2 and 8 are retests at the same conditions as Trials 1 and 7, respectively

The MIC data in Table 15 and Equation 1 above were used to calculate the Synergy Index (“SI”) for each of the inventive compositions presented in Table. The calculated Synergy Indices are tabulated below in Table 16.

TABLE 16
Calculated Synergy Indices of calcium ethylhexanoate-BIT
compositions Based on their observed MIC's for Alternaria alternata

| | | | MIC (ppm) | | | | | |
|---|---|---|---|---|---|---|---|---|
| | Invention | | for | | | | | |
| Trial | or | Mass Ratio | Alternaria | | | | | |
| No. | Comparison | (Mass_{CEHA}:Mass_{BIT}) | alternata | Qa | QA | Qb | QB | SI |
| 1 | Comparison | 0:1 | 13 | 0 | 7.5 | 13 | 13 | Not |
| | | | | | | | | Applicable |
| 2 | Comparison | 0:1 | 13 | 0 | 7.5 | 13 | 13 | Not |
| | | | | | | | | Applicable |
| 3 | Invention | 1:3 | 10 | 2.5 | 7.5 | 7.5 | 13 | <0.910 |
| 4 | Invention | 1:1 | 8 | 4 | 7.5 | 4 | 13 | <0.841 |
| 5 | Invention | 1:1 | 8 | 4 | 7.5 | 4 | 13 | <0.841 |
| 6 | Invention | 3:1 | 7 | 5.25 | 7.5 | 1.75 | 13 | <0.835 |
| 7 | Comparison | 1:0 | 8 | 8 | 7.5 | 0 | 13 | Not |
| | | | | | | | | Applicable |
| 8 | Comparison | 1:0 | 7 | 7 | 7.5 | 0 | 13 | Not |
| | | | | | | | | Applicable |

Legend:
+ Mass_{CEHA} means mass of calcium ethylhexanoate
# Mass_{BIT} means mass of BIT
= Trials 2 and 8 are retests at the same conditions as Trials 1 and 7, respectively

The data in Table 16 demonstrates that equivalent growth inhibition against Alternaria alternata can be achieved by certain calcium ethylhexanoate and BIT mixtures containing less BIT, as compared to growth inhibition by BIT alone. For example, when applied at 1:1 Mass Ratio of calcium ethylhexanoate to BIT, 4 ppm of calcium ethylhexanoate and 4 ppm of BIT provided the same inhibition as 13 ppm of BIT against Alternaria alternate

### Example 9: Effectiveness of Aqueous Calcium Ethylhexanoate and BIT Compositions Against Klebsiella pneumoniae

Utilizing the procedure described above in Example 1, Minimum Inhibitory Concentration (“MIC”) for each of the antimicrobial compositions was determined against a test microbe, which in this case was a spore suspension of the bacteria Klebsiella pneumoniae. Several antimicrobial compositions containing calcium ethylhexanoate, BIT, or both in water were investigated, as shown below in Table 17.

As an average of two trials, the amount of calcium ethylhexanoate (without BIT) required to prevent growth of Klebsiella pneumoniae was 7.5 ppm. All observed values for MIC are presented below in Table 17.

TABLE 17
Aqueous calcium ethylhexanoate-BIT compositions and their
observed MIC's for Klebsiella pneumoniae

| | | Mass | Mass | | |
|---|---|---|---|---|---|
| | Invention | Fraction_{CEHA}+ | Fraction_{BIT}# | Mass | MIC |
| | or | (Mass_{CEHA}/ | (Mass_{BIT}/ | Ratio | (ppm) for |
| Trial | Compar- | Mass_{CEHA} + | Mass_{CEHA} + | (Mass_{CEHA}: | Klebsiella |
| No. | ison | Mass_{BIT}) | Mass_{BIT}) | Mass_{BIT}) | pneumoniae |
| 1 | Compar- | 0 | 1 | 0:1 | 23 |
| | ison | | | | |
| 2 = | Compar- | 0 | 1 | 0:1 | 32 |
| | ison | | | | |
| 3 | Invention | 0.25 | 0.75 | 1:3 | 24 |
| 4 | Invention | 0.5 | 0.5 | 1:1 | 17 |
| 5 | Invention | 0.5 | 0.5 | 1:1 | 19 |
| 6 | Invention | 0.75 | 0.25 | 3:1 | 34 |
| 7 | Compar- | 1 | 0 | 1:0 | >1230 |
| | ison | | | | |
| 8 = | Compar- | 1 | 0 | 1:0 | >1230 |
| | ison | | | | |

Legend: +Mass_{CEHA} means mass of calcium ethylhexanoate
#Mass_{BIT} means mass of BIT
= Trials 2 and 8 are retests at the same conditions as Trials 1 and 7, respectively

The MIC data in Table 17 and Equation 1 above were used to calculate the Synergy Index (“SI”) for each of the inventive compositions presented in Table. The calculated Synergy Indices are tabulated below in Table 18.

TABLE 18
Calculated Synergy Indices of calcium ethylhexanoate-BIT
compositions Based on their observed MIC's for Klebsiella
pneumoniae

| | | | MIC (ppm) | | | | | |
|---|---|---|---|---|---|---|---|---|
| | Invention | | for | | | | | |
| Trial | or | Mass Ratio | Klebsiella | | | | | |
| No. | Comparison | (Mass_{CEHA}:Mass_{BIT}) | pneumoniae | Qa | QA | Qb | QB | SI |
| 1 | Comparison | 0:1 | 23 | 0 | >1230 | 23 | 27 | Not |
| | | | | | | | | Applicable |
| 2 | Comparison | 0:1 | 32 | 0 | >1230 | 32 | 27 | Not |
| | | | | | | | | Applicable |
| 3 | Invention | 1:3 | 24 | 6 | >1230 | 18 | 27 | <0.672 |
| 4 | Invention | 1:1 | 17 | 8.5 | >1230 | 8.5 | 27 | <0.322 |
| 5 | Invention | 1:1 | 19 | 9.5 | >1230 | 9.5 | 27 | <0.360 |
| 6 | Invention | 3:1 | 34 | 25.5 | >1230 | 8.5 | 27 | <0.336 |
| 7 | Comparison | 1:0 | >1230 | 1230 | >1230 | 0 | 27 | Not |
| | | | | | | | | Applicable |
| 8 | Comparison | 1:0 | >1230 | 1230 | >1230 | 0 | 27 | Not |
| | | | | | | | | Applicable |

Legend:
+ Mass_{CEHA} means mass of calcium ethylhexanoate
# Mass_{BIT} means mass of BIT
= Trials 2 and 8 are retests at the same conditions as Trials 1 and 7, respectively

The data in Table 18 demonstrates that equivalent growth inhibition against Klebsiella pneumoniae can be achieved by certain calcium ethylhexanoate and BIT mixtures containing less BIT, as compared to growth inhibition by BIT alone. For example, when applied at 1:1 Mass Ratio of calcium ethylhexanoate to BIT, 9 ppm of calcium ethylhexanoate and 9 ppm of BIT provided the same inhibition as 27 ppm of BIT against Klebsiella pneumoniae.

### Example 10: Effectiveness of Aqueous Zinc Gluconate and BIT Compositions Against Pseudomonas aeruginosa

Utilizing the procedure described above in Example 1, Minimum Inhibitory Concentration (“MIC”) of certain antimicrobial compositions was determined against a test microbe, which in this case was a spore suspension of the bacterium Pseudomonas aeruginosa. Several antimicrobial compositions containing zinc gluconate, BIT, or both in water were investigated, as shown below in Table 19.

The maximum amount of zinc gluconate (without BIT) which the equipment at hand was capable of applying to the malt agar plates proved insufficient to prevent growth of Pseudomonas aeruginosa. The maximum amount of zinc gluconate which the spiral plater actually applied corresponds to 2300 ppm. Because some growth was observed for Pseudomonas aeruginosa at 2300 ppm of calcium gluconate (without BIT), the MIC for calcium gluconate is set forth below in Table 19 as “>2300”.

TABLE 19
Aqueous zinc gluconate-BIT compositions and their observed
MIC's for Pseudomonas aeruginosa

| | | Mass | Mass | | |
|---|---|---|---|---|---|
| | Invention | Fraction_{ZG}+ | Fraction_{BIT}# | Mass | MIC |
| | or | (Mass_{ZG}/ | (Mass_{BIT}/ | Ratio | (ppm) for |
| Trial | Compar- | Mass_{ZG} + | Mass_{ZG} + | (Mass_{CG}: | Pseudomonas |
| No. | ison | Mass_{BIT}) | Mass_{BIT}) | Mass_{BIT}) | aeruginosa |
| 1 | Compar- | 0 | 1 | 0:1 | 604 |
| | ison | | | | |
| 2 = | Compar- | 0 | 1 | 0:1 | 718 |
| | ison | | | | |
| 3 | Invention | 0.25 | 0.25 | 1:3 | 236 |
| 4 | Invention | 0.5 | 0.5 | 1:1 | 212 |
| 5 | Invention | 0.5 | 0.5 | 1:1 | 212 |
| 6 | Invention | 0.75 | 0.25 | 3:1 | 238 |
| 7 | Compar- | 1 | 0 | 0:1 | >2300 |
| | ison | | | | |
| 8 + | Compar- | 1 | 0 | 0:1 | >2300 |
| | ison | | | | |

Legend: +Mass_{ZG} means mass of zinc gluconate
#Mass_{BIT} means mass of BIT
= Trials 2 and 8 are retests at the same conditions as Trials 1 and 7, respectively

The MIC data in Table 19 and Equation 1 above were used to calculate the Synergy Index (“SI”) for each of the inventive compositions presented in Table. The calculated Synergy Indices are tabulated below in Table 20.

TABLE 20
Calculated Synergy Indices of zinc gluconate-BIT compositions
Based on their observed MIC's for Pseudomonas aeruginosa

| | | | MIC (ppm) | | | | | |
|---|---|---|---|---|---|---|---|---|
| | Invention | Mass | for | | | | | |
| Trial | or | Ratio | Pseudomonas | | | | | |
| No. | Comparison | (Mass_{ZG}:Mass_{BIT}) | aeruginosa | Qa | QA | Qb | QB | SI |
| 1 | Comparison | 0:1 | 604 | 0 | >2300 | 70 | 661 | Not |
| | | | | | | | | Applicable |
| 2 | Comparison | 0:1 | 718 | 0 | >2300 | 101 | 661 | Not |
| | | | | | | | | Applicable |
| 3 | Invention | 1:3 | 236 | 59 | >2300 | 177 | 661 | <0.293 |
| 4 | Invention | 1:1 | 212 | 106 | >2300 | 106 | 661 | <0.206 |
| 5 | Invention | 1:1 | 212 | 106 | >2300 | 106 | 661 | <0.206 |
| 6 | Invention | 3:1 | 238 | 178.5 | >2300 | 59.5 | 661 | <0.1676 |
| 7 | Comparison | 1:0 | >2300 | 2300 | >2300 | 0 | 661 | Not |
| | | | | | | | | Applicable |
| 8 | Comparison | 1:0 | >2300 | 2300 | >2300 | 0 | 661 | Not |
| | | | | | | | | Applicable |

Legend:
+ Mass_{ZG} means mass of zinc gluconate
# Mass_{BIT} means mass of BIT
= Trials 2 and 8 are retests at the same conditions as Trials 1 and 7, respectively

The data in Table 20 demonstrate that equivalent growth inhibition against Pseudomonas aeruginosa can be achieved by certain zinc gluconate and BIT mixtures containing less BIT, as compared to growth inhibition by BIT alone. For example, when applied at 1:1 Mass Ratio of zinc gluconate to BIT, about 106 ppm of zinc gluconate and about 106 ppm of BIT provided the same antibacterial inhibition as 661 ppm of BIT. It appears that mixtures of zinc gluconate and BIT may be used to replace BIT as an antibacterial for inhibiting the growth of Pseudomonas aeruginosa in some applications.

### Example 11: Effectiveness of Aqueous Zinc Gluconate and BIT Compositions Against Escherichia coli

Utilizing the experimental procedure described above in Example 1, the MIC against Escherichia coli of several antibacterial compositions containing zinc gluconate, BIT, or both in water were determined. The results are reported below in Table 21.

TABLE 21
Aqueous zinc gluconate-BIT compositions and their MIC's for
Escherichia coli

| | | Mass | Mass | | |
|---|---|---|---|---|---|
| | | Fraction_{ZG}+ | Fraction_{BIT}# | Mass | MIC |
| | Invention | (Mass_{ZG}/ | (Mass_{BIT}/ | Ratio | (ppm) for |
| Trial | or | Mass_{ZG} + | Mass_{ZG} + | (Mass_{CG}: | Escherichia |
| No. | Comparison | Mass_{BIT}) | Mass_{BIT}) | Mass_{BIT}) | coli |
| 1 | Comparison | 0 | 1 | 0:1 | 159 |
| 2 = | Comparison | 0 | 1 | 0:1 | 113 |
| 3 | Invention | 0.25 | 0.25 | 1:3 | 96 |
| 4 | Invention | 0.5 | 0.5 | 1:1 | 56 |
| 5 | Invention | 0.5 | 0.5 | 1:1 | 40 |
| 6 | Invention | 0.75 | 0.25 | 3:1 | 113 |
| 7 | Comparison | 1 | 0 | 0:1 | 531 |
| 8 + | Comparison | 1 | 0 | 0:1 | 600 |

Legend: +Mass_{ZG} means mass of zinc gluconate
#Mass_{BIT} means mass of BIT
= Trials 2 and 8 are retests at the same conditions as Trials 1 and 7, respectively

The MIC data in Table 21 and Equation 1 above were used to calculate the Synergy Index (“SI”) for each of the inventive compositions presented in Table. The calculated Synergy Indices are tabulated below in Table 22.

TABLE 22
Calculated Synergy Indices of zinc gluconate-BIT compositions
Based on their observed MIC's for Escherichia coli

| | | | MIC (ppm) | | | | | |
|---|---|---|---|---|---|---|---|---|
| | Invention | Mass | for | | | | | |
| Trial | or | Ratio | Escherichia | | | | | |
| No. | Comparison | (Mass_{ZG}:Mass_{BIT}) | coli | Qa | QA | Qb | QB | SI |
| 1 | Comparison | 0:1 | 159 | 0 | 565 | 159 | 136 | Not |
| | | | | | | | | Applicable |
| 2 | Comparison | 0:1 | 113 | 0 | 565 | 113 | 136 | Not |
| | | | | | | | | Applicable |
| 3 | Invention | 1:3 | 96 | 24 | 565 | 72 | 136 | <0.572 |
| 4 | Invention | 1:1 | 56 | 28 | 565 | 28 | 136 | <0.250 |
| 5 | Invention | 1:1 | 40 | 20 | 565 | 20 | 136 | <0.182 |
| 6 | Invention | 3:1 | 113 | 84.75 | 565 | 28.25 | 136 | <0.358 |
| 7 | Comparison | 1:0 | 531 | 531 | 565 | 0 | 136 | Not |
| | | | | | | | | Applicable |
| 8 | Comparison | 1:0 | 600 | 600 | 565 | 0 | 136 | Not |
| | | | | | | | | Applicable |

Legend:
+ Mass_{ZG} means mass of zinc gluconate
# Mass_{BIT} means mass of BIT
= Trials 2 and 8 are retests at the same conditions as Trials 1 and 7, respectively

The data in Table 22 demonstrate that equivalent growth inhibition against Escherichia coli can be achieved by certain zinc gluconate and BIT mixtures containing less BIT, as compared to growth inhibition by BIT alone. For example, when applied at 1:1 Mass Ratio of zinc gluconate to BIT, about 24 ppm of zinc gluconate and about 24 ppm of BIT provided the same antibacterial inhibition as 136 ppm of BIT. It appears that mixtures of calcium gluconate and BIT may be used to replace BIT as an antibacterial for inhibiting the growth of Escherichia coli in some applications.

Surprisingly, this data indicates that combining zinc gluconate and BIT in a certain range of mass fractions produces a bactericidal mixture that is more effective than a corresponding amount of either of these materials against Escherichia coli.

### Example 12: Effectiveness of Aqueous Zinc Glycerate and BIT Compositions Against Candida albicans

Utilizing the procedure described above in Example 1, Minimum Inhibitory Concentration (“MIC”) for antimicrobial compositions was determined against a test microbe, which in this case was a spore suspension of the yeast Candida albicans. Several antimicrobial compositions containing calcium glycerate, BIT, or both in water were investigated, as shown below in Table 23.

The maximum amount of zinc glycerate (without BIT) which the equipment at hand was capable of applying to the malt agar plates proved insufficient to prevent growth of Candida albicans. The maximum amount of zinc glycerate which the spiral plater actually applied corresponds to >768 ppm. Because some growth was observed for Candida albicans at 768 ppm of zinc glycerate (without BIT), the MIC for zinc glycerate is set forth below in Table 23 as “>768”.

TABLE 23
Aqueous zinc glycerate-BIT compositions and their
observed MIC's for Candida albicans

| | | Mass | Mass | | |
|---|---|---|---|---|---|
| | | Fraction_{ZGLY}+ | Fraction_{BIT}# | Mass | MIC |
| | Invention | (Mass_{ZGLY}/ | (Mass_{BIT}/ | Ratio | (ppm) for |
| Trial | or | Mass_{ZGLY} + | Mass_{ZGLY} + | (Mass_{ZGLY}: | Candida |
| No. | Comparison | Mass_{BIT}) | Mass_{BIT}) | Mass_{BIT}) | albicans |
| 1 | Comparison | 0 | 1 | 0:1 | 13 |
| 2 = | Comparison | 0 | 1 | 0:1 | 13 |
| 3 | Invention | 0.25 | 0.75 | 1:3 | 12 |
| 4 | Invention | 0.5 | 0.5 | 1:1 | 13 |
| 5 | Invention | 0.5 | 0.5 | 1:1 | 13 |
| 6 | Invention | 0.75 | 0.25 | 3:1 | 16 |
| 7 | Comparison | 1 | 0 | 1:0 | >768 |
| 8 = | Comparison | 1 | 0 | 1:0 | >768 |

Legend: +Mass_{ZGLY} means mass of zinc glycerate
#Mass_{BIT} means mass of BIT
= Trials 2 and 8 are retests at the same conditions as Trials 1 and 7, respectively

The MIC data in Table 23 and Equation 1 above were used to calculate the Synergy Index (“SI”) for each of the inventive compositions presented in Table 20. The calculated Synergy Indices are tabulated below in Table 24.

TABLE 20
Calculated Synergy Indices of zinc glycerate-BIT compositions
Based on their observed MIC's for Candida albicans

| | | | MIC (ppm) | | | | | |
|---|---|---|---|---|---|---|---|---|
| | Invention | | for | | | | | |
| Trial | or | Mass Ratio | Candida | | | | | |
| No. | Comparison | (Mass_{ZGLY}:Mass_{BIT}) | albicans | Qa | QA | Qb | QB | SI |
| 1 | Comparison | 0:1 | 13 | 0 | >768 | 13 | 13 | Not |
| | | | | | | | | Applicable |
| 2 | Comparison | 0:1 | 13 | 0 | >768 | 13 | 13 | Not |
| | | | | | | | | Applicable |
| 3 | Invention | 1:3 | 12 | 3 | >768 | 9 | 13 | <0.696 |
| 4 | Invention | 1:1 | 13 | 6.5 | >768 | 6.5 | 13 | <0.508 |
| 5 | Invention | 1:1 | 13 | 6.5 | >768 | 6.5 | 13 | <0.508 |
| 6 | Invention | 3:1 | 16 | 12 | >768 | 4 | 13 | <0.323 |
| 7 | Comparison | 1:0 | >768 | 768 | >768 | 0 | 16 | Not |
| | | | | | | | | Applicable |
| 8 | Comparison | 1:0 | >768 | 768 | >768 | 0 | 16 | Not |
| | | | | | | | | Applicable |

Legend:
+ Mass_{ZGLY} means mass of zinc glycerate
# Mass_{BIT} means mass of BIT
= Trials 2 and 8 are retests at the same conditions as Trials 1 and 7, respectively

The data in Table 24 demonstrates that equivalent growth inhibition against Candida albicans can be achieved by certain zinc glycerate and BIT mixtures containing less BIT, as compared to growth inhibition by BIT alone. For example, when applied at 1:1 Mass Ratio of zinc glycerate to BIT, 6.5 ppm of zinc glycerate and 6.5 ppm of BIT provided the same inhibition as 13 ppm of BIT against Candida albicans.

### Example 13: Effectiveness of Aqueous Zinc Glycerate and BIT Compositions Against Staphylococcus aureus

Utilizing the procedure described above in Example 1, Minimum Inhibitory Concentration (“MIC”) for antimicrobial compositions was determined against a test microbe, which in this case was a spore suspension of the yeast Staphylococcus aureus. Several antimicrobial compositions containing calcium glycerate, BIT, or both in water were investigated, as shown below in Table 25.

The maximum amount of zinc glycerate (without BIT) which the equipment at hand was capable of applying to the malt agar plates proved insufficient to prevent growth of Staphylococcus aureus. The maximum amount of zinc glycerate which the spiral plater actually applied corresponds to >768 ppm. Because some growth was observed for Staphylococcus aureus at 768 ppm of zinc glycerate (without BIT), the MIC for zinc glycerate is set forth below in Table 25 as “>768”.

TABLE 25
Aqueous zinc glycerate-BIT compositions and their
observed MIC's for Staphylococcus aureus

| | | Mass | Mass | | MIC |
|---|---|---|---|---|---|
| | Invention | Fraction_{ZGLY}+ | Fraction_{BIT}# | Mass | (ppm) for |
| | or | (Mass_{ZGLY}/ | (Mass_{BIT}/ | Ratio | Staphy- |
| Trial | Compar- | Mass_{ZGLY} + | Mass_{ZGLY} + | (Mass_{ZGLY}: | lococcus |
| No. | ison | Mass_{BIT}) | Mass_{BIT}) | Mass_{BIT}) | aureus |
| 1 | Compar- | 0 | 1 | 0:1 | 16 |
| | ison | | | | |
| 2 = | Compar- | 0 | 1 | 0:1 | 16 |
| | ison | | | | |
| 3 | Invention | 0.25 | 0.75 | 1:3 | 12 |
| 4 | Invention | 0.5 | 0.5 | 1:1 | 10 |
| 5 | Invention | 0.5 | 0.5 | 1:1 | 10 |
| 6 | Invention | 0.75 | 0.25 | 3:1 | 9 |
| 7 | Compar- | 1 | 0 | 1:0 | >1283 |
| | ison | | | | |
| 8 = | Compar- | 1 | 0 | 1:0 | >1283 |
| | ison | | | | |

Legend: +Mass_{ZGLY} means mass of zinc glycerate
#Mass_{BIT} means mass of BIT
= Trials 2 and 8 are retests at the same conditions as Trials 1 and 7, respectively

The MIC data in Table 25 and Equation 1 above were used to calculate the Synergy Index (“SI”) for each of the inventive compositions presented in Table 25. The calculated Synergy Indices are tabulated below in Table 26.

TABLE 26
Calculated Synergy Indices of zinc glycerate-BIT compositions
Based on their observed MIC's for Staphylococcus aureus

| | | | MIC (ppm) | | | | | |
|---|---|---|---|---|---|---|---|---|
| | Invention | | for | | | | | |
| Trial | or | Mass Ratio | Staphylococcus | | | | | |
| No. | Comparison | (Mass_{ZGLY}:Mass_{BIT}) | aureus | Qa | QA | Qb | QB | SI |
| 1 | Comparison | 0:1 | 16 | 0 | >1283 | 16 | 16 | Not |
| | | | | | | | | Applicable |
| 2 | Comparison | 0:1 | 16 | 0 | >1283 | 16 | 16 | Not |
| | | | | | | | | Applicable |
| 3 | Invention | 1:3 | 12 | 3 | >1283 | 9 | 16 | <0.565 |
| 4 | Invention | 1:1 | 10 | 5 | >1283 | 5 | 16 | <0.316 |
| 5 | Invention | 1:1 | 10 | 5 | >1283 | 5 | 16 | <0.316 |
| 6 | Invention | 3:1 | 9 | 6.75 | >1283 | 2.25 | 16 | <0.146 |
| 7 | Comparison | 1:0 | >1283 | 1283 | >1283 | 0 | 16 | Not |
| | | | | | | | | Applicable |
| 8 | Comparison | 1:0 | >1283 | 1283 | >1283 | 0 | 16 | Not |
| | | | | | | | | Applicable |

Legend:
+ Mass_{ZGLY} means mass of zinc glycerate
# Mass_{BIT} means mass of BIT
= Trials 2 and 8 are retests at the same conditions as Trials 1 and 7, respectively

The data in Table 26 demonstrates that equivalent growth inhibition against Staphylococcus aureus can be achieved by certain zinc glycerate and BIT mixtures containing less BIT, as compared to growth inhibition by BIT alone. For example, when applied at 1:1 Mass Ratio of zinc glycerate to BIT, 5 ppm of zinc glycerate and 5 ppm of BIT provided the same inhibition as 16 ppm of BIT against Staphylococcus aureus.

### Example 14: Effectiveness of Aqueous Zinc Glycerate and BIT Compositions Against Alternaria alternata

Utilizing the procedure described above in Example 1, Minimum Inhibitory Concentration (“MIC”) for antimicrobial compositions was determined against a test microbe, which in this case was a spore suspension of the fungi Alternaria alternata. Several antimicrobial compositions containing calcium glycerate, BIT, or both in water were investigated, as shown below in Table 27.

The maximum amount of zinc glycerate (without BIT) which the equipment at hand was capable of applying to the malt agar plates proved insufficient to prevent growth of Alternaria alternata. The maximum amount of zinc glycerate which the spiral plater actually applied corresponds to >768 ppm. Because some growth was observed for Alternaria alternata at 768 ppm of zinc glycerate (without BIT), the MIC for zinc glycerate is set forth below in Table 27 as “>768”.

TABLE 27
Aqueous zinc glycerate-BIT compositions and their
observed MIC's for Alternaria alternata

| | | Mass | Mass | | |
|---|---|---|---|---|---|
| | | Fraction_{ZGLY}+ | Fraction_{BIT}# | Mass | MIC |
| | Invention | (Mass_{ZGLY}/ | (Mass_{BIT}/ | Ratio | (ppm) for |
| Trial | or | Mass_{ZGLY} + | Mass_{ZGLY} + | (Mass_{ZGLY}: | Alternaria |
| No. | Comparison | Mass_{BIT}) | Mass_{BIT}) | Mass_{BIT}) | alternata |
| 1 | Comparison | 0 | 1 | 0:1 | 8.3 |
| 2 = | Comparison | 0 | 1 | 0:1 | 8.3 |
| 3 | Invention | 0.25 | 0.75 | 1:3 | 6.8 |
| 4 | Invention | 0.5 | 0.5 | 1:1 | 5.2 |
| 5 | Invention | 0.5 | 0.5 | 1:1 | 5.2 |
| 6 | Invention | 0.75 | 0.25 | 3:1 | 5.3 |
| 7 | Comparison | 1 | 0 | 1:0 | >788 |
| 8 = | Comparison | 1 | 0 | 1:0 | >788 |

Legend: +Mass_{ZGLY} means mass of zinc glycerate
#Mass_{BIT} means mass of BIT
= Trials 2 and 8 are retests at the same conditions as Trials 1 and 7, respectively

The MIC data in Table 27 and Equation 1 above were used to calculate the Synergy Index (“SI”) for each of the inventive compositions presented in Table 27. The calculated Synergy Indices are tabulated below in Table 28.

TABLE 28
Calculated Synergy Indices of zinc glycerate-BIT compositions
Based on their observed MIC's for Alternaria alternata

| | | | MIC (ppm) | | | | | |
|---|---|---|---|---|---|---|---|---|
| | Invention | | for | | | | | |
| Trial | or | Mass Ratio | Alternaria | | | | | |
| No. | Comparison | (Mass_{ZGLY}:Mass_{BIT}) | alternata | Qa | QA | Qb | QB | SI |
| 1 | Comparison | 0:1 | 8.3 | 0 | >788 | 16 | 8.3 | Not |
| | | | | | | | | Applicable |
| 2 | Comparison | 0:1 | 8.3 | 0 | >788 | 16 | 8.3 | Not |
| | | | | | | | | Applicable |
| 3 | Invention | 1:3 | 6.8 | 1.7 | >788 | 5.1 | 8.3 | <0.616 |
| 4 | Invention | 1:1 | 5.2 | 2.6 | >788 | 2.6 | 8.3 | <0.316 |
| 5 | Invention | 1:1 | 5.2 | 2.6 | >788 | 2.6 | 8.3 | <0.316 |
| 6 | Invention | 3:1 | 5.3 | 1.3 | >788 | 4.0 | 8.3 | <0.484 |
| 7 | Comparison | 1:0 | >788 | 788 | >788 | 0 | 8.3 | Not |
| | | | | | | | | Applicable |
| 8 | Comparison | 1:0 | >788 | 788 | >788 | 0 | 8.3 | Not |
| | | | | | | | | Applicable |

Legend:
+ Mass_{ZGLY} means mass of zinc glycerate
# Mass_{BIT} means mass of BIT
= Trials 2 and 8 are retests at the same conditions as Trials 1 and 7, respectively

The data in Table 28 demonstrates that equivalent growth inhibition against Alternaria alternata can be achieved by certain zinc glycerate and BIT mixtures containing less BIT, as compared to growth inhibition by BIT alone. For example, when applied at 1:1 Mass Ratio of zinc glycerate to BIT, 2.6 ppm of zinc glycerate and 2.6 ppm of BIT provided the same inhibition as 8.3 ppm of BIT against Alternaria alternata.

### Example 15: Effectiveness of Aqueous Zinc Ethylhexanoate and BIT Compositions Against Alternaria alternata

Utilizing the procedure described above in Example 1, Minimum Inhibitory Concentration (“MIC”) for each of the antimicrobial compositions was determined against a test microbe, which in this case was a spore suspension of the fungus Alternaria alternata. Several antimicrobial compositions containing zinc ethylhexanoate, BIT, or both in water were investigated, as shown below in Table 29.

As an average of two trials, the amount of zinc ethylhexanoate (without BIT) required to prevent growth of Alternaria alternata was >780 ppm. All observed values for MIC are presented below in Table 29.

TABLE 29
Aqueous zinc ethylhexanoate-BIT compositions and their
observed MIC's for Alternaria alternata

| | | Mass | Mass | | |
|---|---|---|---|---|---|
| | | Fraction_{ZEHA}+ | Fraction_{BIT}# | Mass | MIC |
| | Invention | (Mass_{ZEHA}/ | (Mass_{BIT}/ | Ratio | (ppm) for |
| Trial | or | Mass_{ZEHA} + | Mass_{ZEHA} + | (Mass_{ZEHA}: | Alternaria |
| No. | Comparison | Mass_{BIT}) | Mass_{BIT}) | Mass_{BIT}) | alternata |
| 1 | Comparison | 0 | 1 | 0:1 | 13 |
| 2 = | Comparison | 0 | 1 | 0:1 | 13 |
| 3 | Invention | 0.25 | 0.75 | 1:3 | 11 |
| 4 | Invention | 0.5 | 0.5 | 1:1 | 8 |
| 5 | Invention | 0.5 | 0.5 | 1:1 | 8 |
| 6 | Invention | 0.75 | 0.25 | 3:1 | 10 |
| 7 | Comparison | 1 | 0 | 1:0 | >780 |
| 8 = | Comparison | 1 | 0 | 1:0 | >780 |

Legend: +Mass_{ZEHA} means mass of zinc ethylhexanoate
#Mass_{BIT} means mass of BIT
= Trials 2 and 8 are retests at the same conditions as Trials 1 and 7, respectively

The MIC data in Table 29 and Equation 1 above were used to calculate the Synergy Index (“SI”) for each of the inventive compositions presented in Table. The calculated Synergy Indices are tabulated below in Table 30.

TABLE 30
Calculated Synergy Indices of zinc ethylhexanoate-BIT
compositions Based on their observed MIC's for Alternaria alternata

| | | | MIC (ppm) | | | | | |
|---|---|---|---|---|---|---|---|---|
| | Invention | | for | | | | | |
| Trial | or | Mass Ratio | Alternaria | | | | | |
| No. | Comparison | (Mass_{ZEHA}:Mass_{BIT}) | alternata | Qa | QA | Qb | QB | SI |
| 1 | Comparison | 0:1 | 13 | 0 | >780 | 13 | 13 | Not |
| | | | | | | | | Applicable |
| 2 | Comparison | 0:1 | 13 | 0 | >780 | 13 | 13 | Not |
| | | | | | | | | Applicable |
| 3 | Invention | 1:3 | 11 | 1.875 | >780 | 8.25 | 13 | <637 |
| 4 | Invention | 1:1 | 8 | 4 | >780 | 4 | 13 | <0.313 |
| 5 | Invention | 1:1 | 8 | 4 | >780 | 4 | 13 | <0.313 |
| 6 | Invention | 3:1 | 10 | 7.5 | >780 | 2.5 | 13 | <0.193 |
| 7 | Comparison | 1:0 | >780 | >780 | >780 | 0 | 13 | Not |
| | | | | | | | | Applicable |
| 8 | Comparison | 1:0 | >780 | >780 | >780 | 0 | 13 | Not |
| | | | | | | | | Applicable |

Legend:
+ Mass_{ZEHA} means mass of zinc ethylhexanoate
# Mass_{BIT} means mass of BIT
= Trials 2 and 8 are retests at the same conditions as Trials 1 and 7, respectively

The data in Table 30 demonstrates that equivalent growth inhibition against Alternaria alternata can be achieved by certain zinc ethylhexanoate and BIT mixtures containing less BIT, as compared to growth inhibition by BIT alone. For example, when applied at 1:1 Mass Ratio of zinc ethylhexanoate to BIT, 4 ppm of zinc ethylhexanoate and 4 ppm of BIT provided the same inhibition as 13 ppm of BIT against Alternaria alternata.

### Example 16: Effectiveness of Aqueous Zinc Ethylhexanoate and BIT Compositions Against Candida Albicans

Utilizing the procedure described above in Example 1, Minimum Inhibitory Concentration (“MIC”) for each of the antimicrobial compositions was determined against a test microbe, which in this case was a spore suspension of the fungus Candida Albicans. Several antimicrobial compositions containing zinc ethylhexanoate, BIT, or both in water were investigated, as shown below in Table 31.

The maximum amount of zinc glycerate (without BIT) which the equipment at hand was capable of applying to the malt agar plates proved insufficient to prevent growth of Candida albicans. The maximum amount of zinc ethylhexanoate which the spiral plater actually applied corresponds to >780 ppm. Because some growth was observed for Candida albicans at 780 ppm of zinc glycerate (without BIT), the MIC for zinc glycerate is set forth below in Table 31 as “>780”.

TABLE 31
Aqueous zinc ethylhexanoate-BIT compositions and their
observed MIC's for Candida albicans

| | | Mass | Mass | | |
|---|---|---|---|---|---|
| | | Fraction_{ZEHA}+ | Fraction_{BIT}# | Mass | MIC |
| | Invention | (Mass_{ZEHA}/ | (Mass_{BIT}/ | Ratio | (ppm) for |
| Trial | or | Mass_{ZEHA} + | Mass_{ZEHA} + | (Mass_{ZEHA}: | Candida |
| No. | Comparison | Mass_{BIT}) | Mass_{BIT}) | Mass_{BIT}) | Albicans |
| 1 | Comparison | 0 | 1 | 0:1 | 23 |
| 2 = | Comparison | 0 | 1 | 0:1 | 15 |
| 3 | Invention | 0.25 | 0.75 | 1:3 | 19 |
| 4 | Invention | 0.5 | 0.5 | 1:1 | 9 |
| 5 | Invention | 0.5 | 0.5 | 1:1 | 20 |
| 6 | Invention | 0.75 | 0.25 | 3:1 | 37 |
| 7 | Comparison | 1 | 0 | 1:0 | >780 |
| 8 = | Comparison | 1 | 0 | 1:0 | >780 |

Legend: +Mass_{ZEHA} means mass of zinc ethylhexanoate
#Mass_{BIT} means mass of BIT
= Trials 2 and 8 are retests at the same conditions as Trials 1 and 7, respectively

The MIC data in Table 31 and Equation 1 above were used to calculate the Synergy Index (“SI”) for each of the inventive compositions presented in Table. The calculated Synergy Indices are tabulated below in Table 32.

TABLE 32
Calculated Synergy Indices of zinc ethylhexanoate-BIT
compositions Based on their observed MIC's for Candida albicans

| | | | MIC (ppm) | | | | | |
|---|---|---|---|---|---|---|---|---|
| | Invention | | for | | | | | |
| Trial | or | Mass Ratio | Candida | | | | | |
| No. | Comparison | (Mass_{ZEHA}:Mass_{BIT}) | Albicans | Qa | QA | Qb | QB | SI |
| 1 | Comparison | 0:1 | 23 | 0 | >780 | 23 | 19 | Not |
| | | | | | | | | Applicable |
| 2 | Comparison | 0:1 | 15 | 0 | >780 | 15 | 19 | Not |
| | | | | | | | | Applicable |
| 3 | Invention | 1:3 | 19 | 4.75 | >780 | 14.25 | 19 | <0.756 |
| 4 | Invention | 1:1 | 9 | 4.5 | >780 | 4.5 | 19 | <0.243 |
| 5 | Invention | 1:1 | 20 | 10 | >780 | 10 | 19 | <0.539 |
| 6 | Invention | 3:1 | 37 | 27.75 | >780 | 9.25 | 19 | <0.522 |
| 7 | Comparison | 1:0 | >780 | >780 | >780 | 0 | 19 | Not |
| | | | | | | | | Applicable |
| 8 | Comparison | 1:0 | >780 | >780 | >780 | 0 | 19 | Not |
| | | | | | | | | Applicable |

Legend:
+ Mass_{ZEHA} means mass of zinc ethylhexanoate
# Mass_{BIT} means mass of BIT
= Trials 2 and 8 are retests at the same conditions as Trials 1 and 7, respectively

The data in Table 32 demonstrate that equivalent growth inhibition against Candida albicans can be achieved by certain zinc ethylhexanoate and BIT mixtures containing less BIT, as compared to growth inhibition by BIT alone. For example, when applied at 1:1 Mass Ratio of zinc ethylhexanoate to BIT, about 7.25 ppm of zinc ethylhexanoate and about 7.25 ppm of BIT provided the same inhibition as 19 ppm of BIT against Candida Albicans.

### Example 17. Bacterial Effectiveness Against a Mixed Inoculum

In order to quantify the antibacterial effectiveness of an antimicrobial composition of interest, samples were prepared by adding various amounts of the antimicrobial composition to identical volumes of a paint that contained no preservatives and was not contaminated by bacteria. In this case, the test sample was a white, aqueous-based, acrylic latex paint. The paint included an acrylic resin, and conventional additives such as surfactant, thickener, defoamer, and titanium oxide. Because the paint exhibited no observable growth after five days of incubation on Tryptone Glucose Extract Agar at 30 degrees C., the paint was not contaminated by bacteria.

The samples of the paint were subjected to a two-part challenge procedure and the sample that provided acceptable anti-bacterial protection with the lowest concentration of the antimicrobial composition was identified. Each part of the anti-bacterial challenge consisted of a 7-day test cycle. The parts were performed consecutively over 14 test days. Acceptable anti-bacterial protection is achieved when the test product exhibits complete inhibition at the end of the second seven-day cycle. Even if a sample exhibited bacterial growth earlier in the challenge procedure, it was the final reading at the end of the 14 test days that determined whether anti-bacterial protection was acceptable.

Challenge testing was accomplished using a mixed bacterial inoculum as the contamination event. These bacteria are Pseudomonas aeruginosa (ATCC #10145), Escherichia coli (ATCC #11229), Enterobacter aerogenes (ATCC #13048), and Alcaligenes faecalis (ATCC #25094). To prepare the test inoculum, each type of bacteria was harvested separately in nutrient broth. Just before use in the challenge test, equal strengths of each bacterial culture were mixed to obtain an inoculum of approximately 10⁸ colony forming units per milliliter (cfu/mL).

After incubation, both control blanks and samples containing preservatives of interest were inoculated with the mixed inoculum to a final of 1.0 weight %. The mixed inoculum was stirred evenly through the paint, incubated at room temperature, and then streaked on agar plates after incubation periods of one day, two days, and seven days.

Performance ratings of 0, 1, 2, 3 or 4 for each inoculated paint sample were determined by visual inspection of the streak lines, according to the definitions set forth below in Table 25.

TABLE 33

| Performance Rating | Definition |
|---|---|
| 0 | No bacterial growth |
| 1 | Trace of bacterial growth |
| 2 | Light bacterial growth |
| 3 | Moderate bacterial growth |
| 4 | Heavy bacterial growth |

Performance ratings observed for the inoculated paint samples at various times after inoculation are presented below in Table 34.

TABLE 34
Performance Ratings of Inoculated Paint Samples

| Time After | | | | | | | |
|---|---|---|---|---|---|---|---|
| Inoculation | Performance Ratings | | | | | | INVENTION |
| Preservatives in | Week 1 | | | Week 2 | | | or |
| Paint Sample* | 1 Day | 2 Days | 8 Days | 1 Day | 2 Days | 8 Days | COMPARISON |
| Control | 4 | 4 | 4 | 4 | 4 | 4 | COMPARISON |
| (no preservative) | | | | | | | |
| 5000 ppm | 4 | 4 | 4 | 4 | 4 | 4 | COMPARISON |
| Zinc Gluconate | | | | | | | |
| 1000 ppm Zinc | 4 | 4 | 4 | 4 | 4 | 4 | INVENTION |
| Gluconate + | | | | | | | |
| 37.5 ppm BIT | | | | | | | |
| 5000 ppm | 4 | 3 | 0 | 4 | 4 | 0 | INVENTION |
| Zinc gluconate + | | | | | | | |
| 50 ppm BIT | | | | | | | |
| 50 ppm BIT | 4 | 4 | 4 | 4 | 4 | 4 | COMPARISON |
| 500 ppm BIT | 4 | 2 | 0 | 4 | 4 | 0 | COMPARISON |

The data in Table 34 demonstrates that a conventional latex paint to which 5000 ppm of zinc gluconate has been added fails the bacterial stability test, yet the paint passes the test when 5000 ppm zinc gluconate is added together with 50 BIT. Surprisingly, the level of antibacterial effectiveness provided by 5000 ppm zinc gluconate with 50 BIT is equal to that provided by 500 ppm BIT.

The data in Table 35 demonstrates that a conventional latex paint to which 5000 ppm of zinc gluconate has been added fails the bacterial stability test, yet the paint passes the test when 5000 ppm zinc gluconate is added together with 50 BIT. Surprisingly, the level of antibacterial effectiveness provided by 5000 ppm zinc gluconate with 50 BIT is equal to that provided by 500 ppm BIT.

The data indicates that compositions of the invention provide protection against all of the bacteria present in the mixed inoculum, (which includes Pseudomonas aeruginosa, Escherichia coli, Enterobacter aerogenes, and Alcaligenes faecalis) because even one of the inoculated bacteria would produce detectable growth if left uninhibited for seven days.

Based on a survey of national statutes, several governmental regulatory agencies find paint with 5000 ppm zinc gluconate and 50 BIT less harmful to the environment than paint with 500 BIT. The option of replacing a portion of BIT preservative in paint is presently used in paint is surprising, when one considers that zinc gluconate has been utilized as a dietary supplement for people.

### Example 18: Attempts at Treating Conventional Acrylic Paint with Zinc Acetate, Zinc Formate, or ZincChloride

Experiments were conducted to establish whether zinc acetate, zinc formate, or zinc chloride could be used in a conventional acrylic paint to boost preservative activity against bacterial degradation. The ingredients of the acrylic paint are presented below in Table 35.

TABLE 35
Ingredients of a Conventional White Acrylic Exterior Paint

| | Weight | Ingredient | Supplier |
|---|---|---|---|
| Ingredient | (per cent | (Trade Name | Name or |
| No. | of total) | or Description) | Commodity |
| 1 | 0.3 | Natrosol 250 MHR | Aqualon |
| | | 100% | |
| 2 | 1.7 | Propylene glycol | Commodity |
| 3 | 0.9 | Tamol 850 (30%) | Rohm & Haas |
| 4 | 0.12 | KTPP | FMC |
| 5 | 0.1 | Nopco NXZ | Hüls |
| 6 | 0.21 | Triton CF-10 | Union Carbide |
| 7 | 13.44 | Water | Commodity |
| 8 | 14.5 | Titanium dioxide | Kerr MCGlyee |
| 9 | 15.7 | Minex 4 | Uniman |
| 10 | 6.4 | Silica (Silver Bond B) | Uniman |
| 11 | 0.85 | Attagel | Engelhard |
| 12 | 6.31 | UCAR 379 | Union Carbide |

Zinc chloride, zinc formate and zinc acetate were added to the acrylic paint formulation. These zinc compounds, which are not of the invention, were blended into the acrylic paint and the viscosity of the blend was examined. Observations on the viscosity of the resulting blended are presented below in Table 28

TABLE 36
Viscosity of Conventional Acrylic Paint with
1 mass % Zinc Acetate, Zinc Formate, or ZincChloride

| Trial | Ingredient added at 1 mass % | |
|---|---|---|
| No. | based on total mass of paint | Observation |
| 1 | Zinc formate | Paint gelled immediately |
| 2 | Zinc acetate | Paint gelled after mixing for |
| | | a few minutes |
| 3 | Zinc chloride | Paint gelled immediately |

The observations in Table 28 demonstrate that zinc acetate, zinc formate, and zinc chloride have little utility for boosting the activity of preservatives for preserving paint, because the material actually caused the paint to gel.

While certain embodiments of the invention have been described above with particularity, it will be recognized that various modifications of the described embodiments will occur to those skilled in the art whose study this application. Such modifications are also within the scope of the appended claims.

That which is claimed is:

1. An antimicrobial composition of matter, which comprises:
(a) a divalent metal carboxylate of the formula:
M⁺²[(R—COOH)⁻¹]₂
where M⁺² is a metal cation, in which M is a metal in the +2 oxidation state; and
[(R—COOH)⁻¹] is a carboxylate anion having a net charge of −1; and
where COOH is a carboxyl group and and
R— is a hydrocarbyl group or a hydroxylhydrocarbyl group and includes two to seven carbon atoms; and
(b) 1, 2-benzisothiazolin-3-one;
in which composition the mass ratio of (a):(b) is in the range of about 1:1,000 to about 1,000:1.

2. The composition of claim 1 in which M is zinc or calcium.

3. The composition of claim 1 in which R is a hydrocarbyl group

4. The composition of claim 1 in which the anion is ethylhexanoate.

5. The composition of claim 1 in which R is a hydroxyhydrocarbyl group.

6. The composition of claim 1 in which the anion R is lactate, glycerate, gluconate or a mixture of thereof.

7. The composition of claim 1, which is an antibacterial.

8. The composition of claim 1, which is an antifungal.

9. The composition of claim 1, which is a yeast inhibitor.

10. The composition of claim 1, in which the mass ratio of (a):(b) is in the range of about 1:500 to about 500:1 and exhibits antimicrobial synergy.

11. The composition of claim 1, which exhibits antimicrobial biocidal synergy.

12. A water-based paint that includes in the range of about 0.1 percent about 15 percent of the composition of claim 1.

13. A dry film coating produced by drying the water-based paint of claim 12.

14. A method for manufacturing a water-based, film-forming coating precursor that resists microbial degradation, which method comprises:
blending a water-based, film-forming coating precursor with the composition of claim 1 to produce an antimicrobial coating precursor that resists microbial degradation by inhibiting microbial growth.

15. The method of claim 14 in which the coating precursor resists microbial degradation by inhibiting microbial growth of one or more of Alternaria alternatas, Candida albicans, Saccharoamyces cervisiae, Pseudomonas aeruginosa, Escherichia coli, Klebsiella pneumoniae, Staphylococcus aureus, Enterobacter aerogenes and Alcaligenes faecalis.

16. The method of claim 15 in which the coating precursor resists microbial degradation by inhibiting microbial growth of one or more of Pseudomonas aeruginosa, Escherichia coli, Enterobacter aerogenes, and Alcaligenes faecalis.

17. A method for manufacturing a dry film coating that resists microbial degradation, which method comprises:
blending a water-based, film-forming coating precursor with the composition of claim 1 to produce an antimicrobial coating precursor, and
exposing the coating precursor to an oxygen-containing gas to produce a dry film coating that resists microbial degradation by inhibiting microbial growth.

18. The method of claim 17 in which the film coating resists microbial degradation by inhibiting microbial growth of one or more of Alternaria alternatas Candida albicans, Saccharoamyces cervisiae, Pseudomonas aeruginosa, Escherichia coli, Klebsiella pneumoniae, Staphylococcus aureus, Enterobacter aerogenes, and Alcaligenes faecalis.

19. The method of claim 18 in which the film coating resists microbial degradation by inhibiting microbial growth of one or more of Pseudomonas aeruginosa, Escherichia coli, Enterobacter aerogenes, and Alcaligenes faecalis.
